(19) United States
(12) Patent Application Publication
(10) Pub. No.: US 2007/0061424 A1
(43) Pub. Date: Mar. 15, 2007

(54) System and method for providing a database of past life information using a virtual cemetery, virtual tomb and virtual safe organizational paradigm

(75) Inventor: Shane D. Mattaway, Coral Gables, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Wholived, Inc., Coral Gables, FL (US)

(21) Appl. No.: 11/371,441

(22) Filed: Mar. 9, 2006

Related U.S. Application Data
(60) Provisional application No. 60/660,113, filed on Mar. 9, 2005.

(51) Int. Cl. G06F 15/16

(52) U.S. Cl. 709/219

(57) ABSTRACT

A computer system includes a computer server and a database that are communicatively linked via a wide area network, such as the world wide web, with a plurality of web browsers. The computer system including a plurality of webcemeteries, webvaults, webtombs and websafes for storing multimedia information associated with lives, past or present. The computer server can invoke a web agent to gather information requested for a webtomb or webvault. An action server associated with each webtomb or webvault can automatically execute actions requested by the webtomb or webvault, such as from a script or program. The actions allow the webtomb or webvault to cause, for example, documents to be transferred, emails or other types of messages to be sent, money to be distributed or transferred to bank accounts, professional services to be authorized, and links with other webtombs or webvaults to be established.

### CROSS-REFERENCE TO RELATED APPLICATION

This application is based on, and claims priority from, prior co-pending U.S. Provisional Patent Application No. 60/660,113, filed on Mar. 9, 2005, the entire disclosure of which being herein incorporated by reference.

### FIELD OF THE INVENTION

The present invention generally relates to the field of database related services, cemetery and funeral related services and to computer network communications, and more particularly relates to a system and method for providing a virtual cemetery, a virtual tomb, a virtual vault, and a virtual safe and related funeral and estate planning services.

### BACKGROUND OF THE INVENTION

Collecting and maintaining information about past lives has been an ad hoc process at best, typically accomplished by using paper records containing some information about a deceased. This limited information has been collected in very limited geographic area, such as with respect to a particular deceased person in a physical tomb in a physical cemetery. The limited information is typically collected by a government agency that maintains death records and possibly maintains some statistics of a geographically limited population. There has not been possible a way to systematically collect and archive a rich amount of historical information about present and past lives over unrestricted geographic areas.

Additionally, any type of actions to be taken in the future relating to a past life, such as by professionals following a legal document such as a will or a trust document, are almost invariable based on very rigidly formalistic paper documents that are maintained to effect the wishes of a deceased person. These professionals typically perform manual procedures based on the instructions expressed in these paper documents to implement the wishes of the deceased person. There has not been possible a way to automatically act on the expressed instructions and wishes of a deceased person.

Therefore a need exists to overcome the problems with the prior art as discussed above.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating an exemplary wholived system according to an embodiment of the present invention.

FIG. 2 is a more detailed block diagram showing more details of the exemplary wholived system of FIG. 1.

FIG. 3 is a communication block diagram showing a wholived server, a webcemetery server, and intercommunications with web browsers, in the exemplary wholived system of FIG. 1.

FIG. 4 is a data diagram showing a more detailed view of database information stored in the wholived system of FIG. 1, according to an embodiment of the present invention.

FIGS. 5, 6, and 7, are functional block diagrams showing relationships between stored database information and a user interface for creating, adding, modifying, and accessing webtomb information and webcemetery information, according to an embodiment of the present invention.

FIG. 8 is a data block diagram showing an example of stored database information that may be searchable from a user interface for accessing webtomb information and webcemetery information, according to an embodiment of the present invention.

FIG. 9 is a data block diagram showing an example of stored database information that may be accessible from a user interface for creating, adding, modifying, and accessing webvault information, according to an embodiment of the present invention.

FIGS. 10 and 11 are block diagrams illustrating an exemplary genealogy browser system, according to an embodiment of the present invention.

FIG. 12 is a functional block diagram showing an example of an action server in the exemplary wholived system of FIG. 1, according to an embodiment of the present invention.

FIG. 13 is a block diagram showing a payment server in the exemplary wholived system of FIG. 1, according to an embodiment of the present invention.

FIG. 14 is a block diagram illustrating communications in an exemplary network and an exemplary wholived system, according to an embodiment of the present invention.

FIG. 15 is a diagram showing front and side views of a biometric lock device for use in the exemplary wholived system of FIG. 1, in the exemplary wholived system of FIG. 1, according to an embodiment of the present invention.

FIGS. 16 to 40 are a collection of screen shots of a display illustrating various examples and scenarios of a user using the exemplary wholived system of FIG. 1, according to exemplary embodiments of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A webVault (also referred to as a virtual vault), is a secure, intelligent storage container residing in wholived that manages and protects the information pertaining to a living person's or pet's life history (also referred to as a present life). Information is comprised of digital media (text, application documents, photos, scan and fax images. videos, music, web pages, etc.). A collection of information, such as a collection of multimedia information, is organized in a webvault in one or more databases in the wholived system. These one or more databases are coupled to at least one wholived computer server and can be accessed by the wholived system, and users, to add information, delete information, and search for information, according to the wholived system features and functions as discussed herein. A webTomb (also referred to as a virtual tomb) is identical to a webVault except its occupant is deceased (also referred to as a past life) and it may reside in one or more virtual cemeteries (webCemeteries) in addition to residing in wholived. When a webVault occupant passes away, his/her/its webVault automatically is converted into a webTomb.

WebVaults reside in wholived.

webTombs reside in wholived and may reside in one or more webCemeteries.

webTombs and webVaults are viewed with webTomb or webVault browsers.

A webcemetery is a collection of webTombs and is viewed with a wholived webCemetery browser.

The wholived system provides a network interface, such as a web browser interface, to allow a remotely located networked application, such as a networked viewer or a web browser viewer, or the like, to access a webTomb or webVault or webSafe or webCemetery in the wholived system. Such a networked application interface, or web browser interface, or the like, may be referred to herein interchangeably as a browser or web browser without limiting the intended meaning of such a networked application interface to include network communication with all forms of applications that have a network access capability and can remotely (via a network) access the wholived system. Wholived, accordingly, provides such a browser that

1) enables users with permission to view and contribute information describing the occupant's life history. Each piece of media comprising the Information about the occupant of a webVault or webTomb may be associated (when added or edited) with one or more defined events in the life history of the occupant. Each event can have a title, textual and audio description and correspond to one or more Categories of information type, the dates and times of the occurrence and duration of the event, the geographical location(s) corresponding to the occurrence of the event and one or more family, friends and Others involved in the event.

2) enables the user to view the occupant's Vital information and Biographical synopsis AND with permission, access, filter and display other information by selecting one or more
Categories/SubCategories pertaining to the desired information AND/OR
Events in the life of the occupant via the integrated Chronicle dialog AND/OR

Family, Friends or Others associated with the desired information via the integrated Family Genealogy dialog.

Example: when one or more family members are selected in the integrated Family Genealogy dialog, all information about the occupant that is related to the selected Family is displayed. If one or more events in the Chronicle dialog are selected all the information about the occupant related to the selected events is displayed. If both family and events are selected then only that information about the occupant that relates to the selected event(s) AND the selected family are displayed (i.e. filter information by event and people involved). This method of information selection and filtering works also with selected categories/subcategories of information as well.

A webVault or webTomb can be scheduled by the occupant or a custodian to automatically perform scheduled actions on behalf of the occupant like email multimedia cards, send flowers to family and friends, fax documents, email media and place telephone calls with prerecorded messages, etc!

A webSafe (also referred to as virtual safe or virtual lock-box) is a secure, intelligent storage container residing in a webVault or webTomb that manages and protects the information pertaining to the occupant's personal property, financial doings and legal affairs. That is, a collection of information, such as a collection of multimedia information, is securely stored and organized as a webSafe in one or more databases in the wholived system.

A webSafe can be scheduled by the occupant or a custodian to automatically perform financial transaction actions such as transferring funds, selling and purchasing stocks and bonds, create and submit tax returns, sell personal property via online auctions, etc., on behalf of the occupant of the webVault or webTomb.

Information added contained in a webVault or webTomb that is related to one or more events and/or one or more family, friends or others involved is used by wholived (such as by using a linkage search agent) to automatically establish possible Relational Linkages of that information to other webVault or webTomb occupants that have the same events and/or family, friends or others in common. For example: when a picture is added to a given webTomb and associated with an event and people involved, other webTombs or webVaults whose occupant's have the same event defined or were one of the people involved are notified that information (a photo in this case) that may involve them is available for validation and incorporation. In this way, a webTomb's or webVault's may become populated with additional associated information not added by the occupant or custodian. Wholived also employs a web search agent to automatically gather information about occupants in webTombs and webVaults and notifies the occupant or custodian that possible associated information exists that requires validation for incorporation. This web search agent employs heuristics to determine if a given piece of information is associated with a particular webTomb or webVault occupant.

The present invention, according to an embodiment, overcomes problems with the prior art by providing a plurality of computer systems interconnected over a wide area network with distributed data storage for providing access to one or more virtual vaults, to one or more virtual cemeteries and one or more virtual tombs therein associated with the cemeteries. Users are able to access and update information associated with the virtual tombs and virtual vaults in an interactive fashion. The information can include rich multimedia content, such as video, audio, still images, data, text documents, and executable routines and scripts. These and other features of the present invention will be discussed in more detail below.

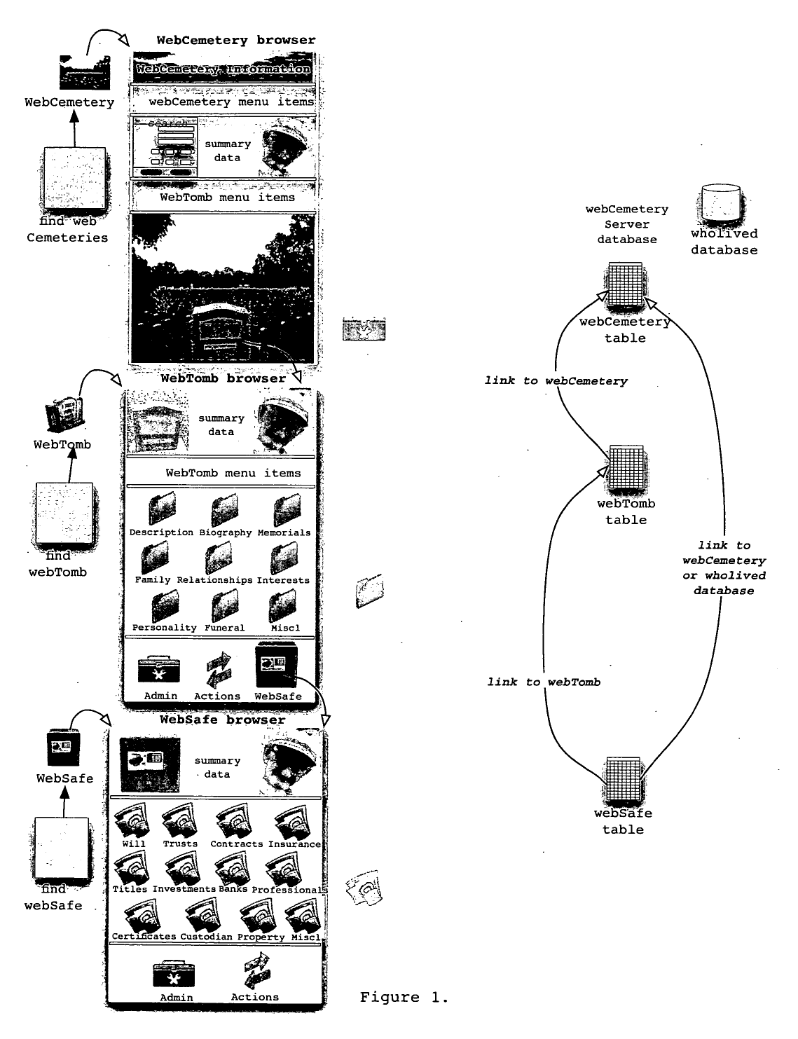

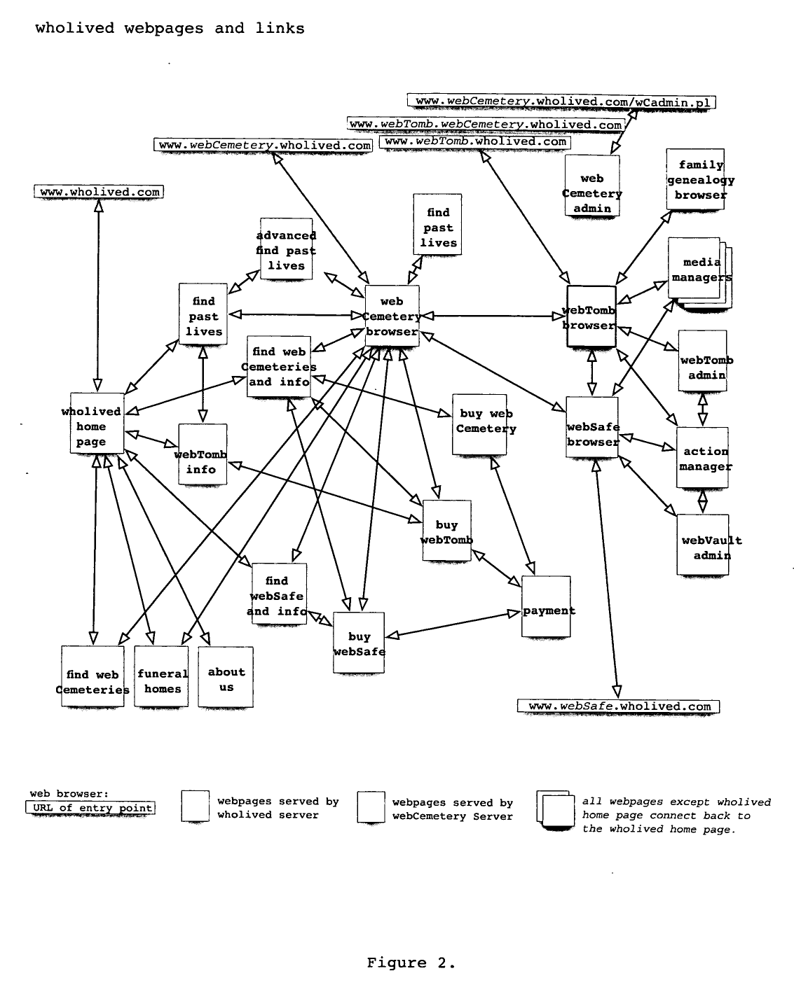

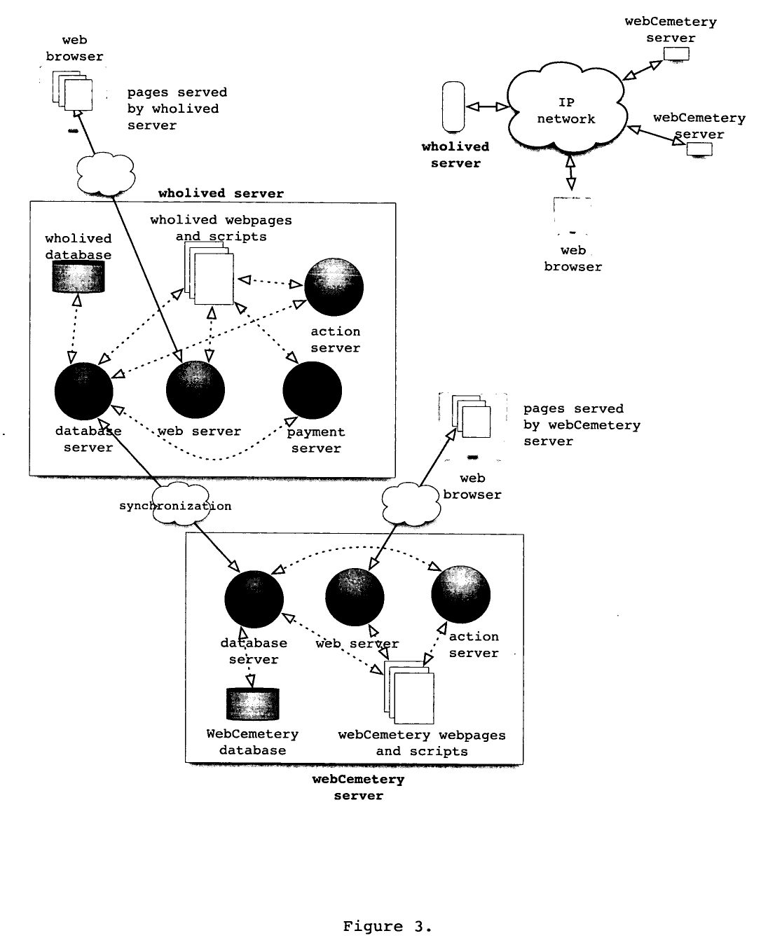

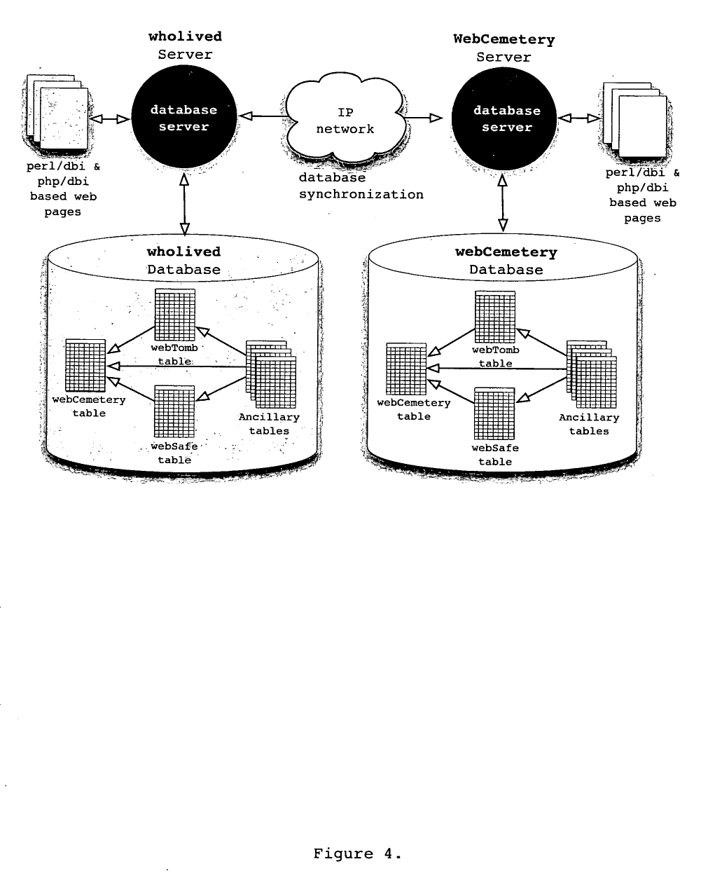

According to an embodiment of the present invention, as shown in FIG. 1, a wholived system comprises one or more networks, such as including one or more local area and/or wide area networks, that interconnect a wholived computer system with other network nodes. The other network nodes typically include one or more web cemetery servers having webcemetery databases, and one or more browsers. The network can comprise the Internet and the world wide web, and the one or more browsers in this case would comprise web browsers. The wholived system includes a web browser interface that can provide remote access to a stored collection of information organized as the plurality of webtombs and/or webvaults from a remote web browser communicating with the at least one computer server from across the communication network. According to one exemplary embodiment of the present invention, the stored collection of information is stored in one or more databases that are communicatively coupled with the wholived computer server. A user using the remote web browser can remotely access such stored collection of information organized as the plurality of webtombs and/or webvaults. A user can provide user input to the wholived computer server, such as by entering information via a keyboard, keypad, mouse, electronic stylus, or via a voice input device (with voice recognition), or via another user input device as should be well known and understood by those of ordinary skill in the art in view of the present discussion. See FIGS. 3 and 4 for more detailed views of the objects and databases typically found in a wholived system such as shown in FIGS. 1 and 2.

FIGS. 1 and 2, in this example, illustrate a wholived system that includes a wholived central server and remote wholived affiliate systems, as shown, and further includes a wide area network such as the Internet and the world wide web.

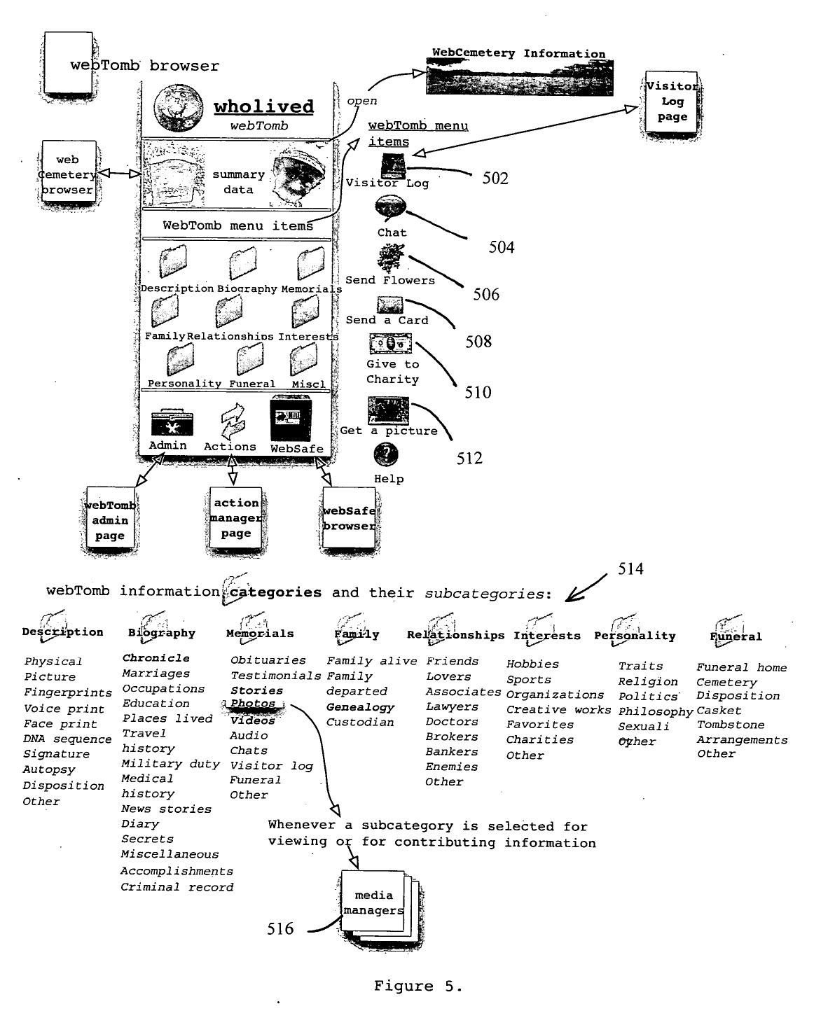

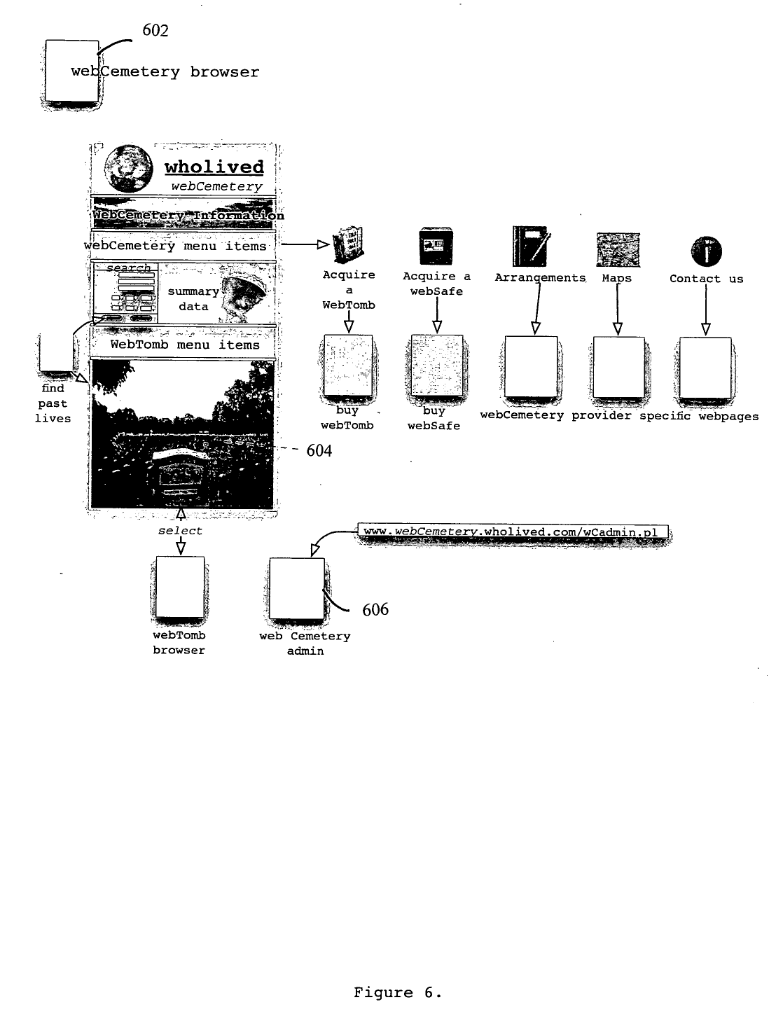

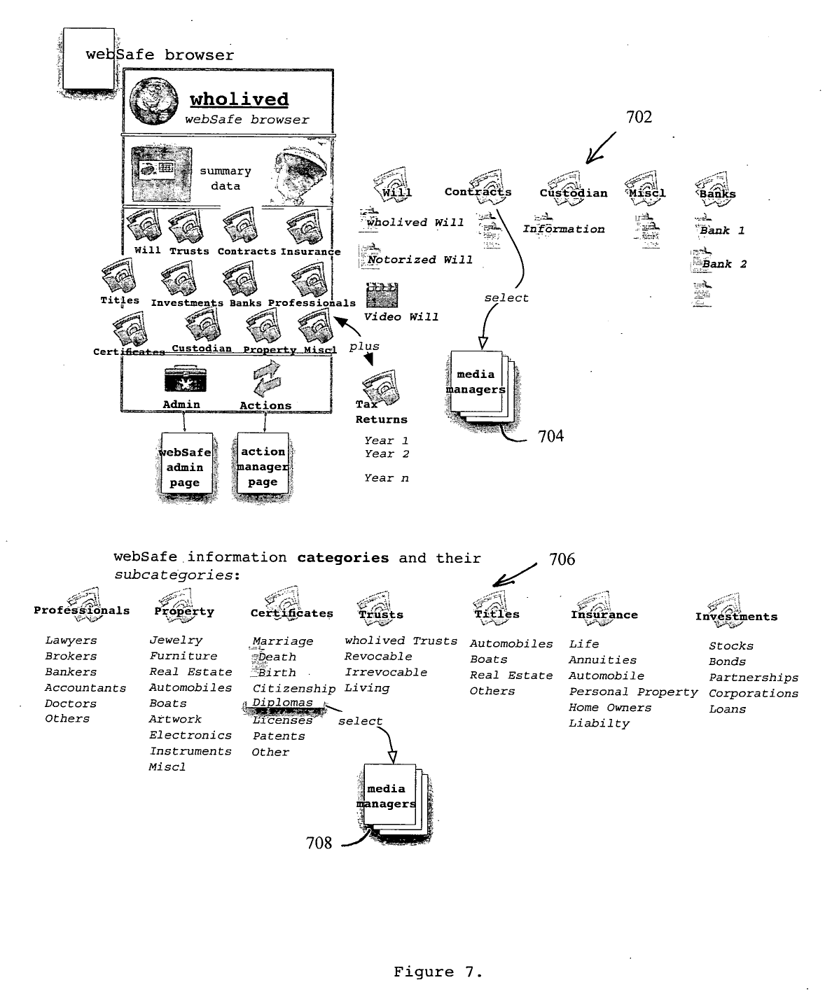

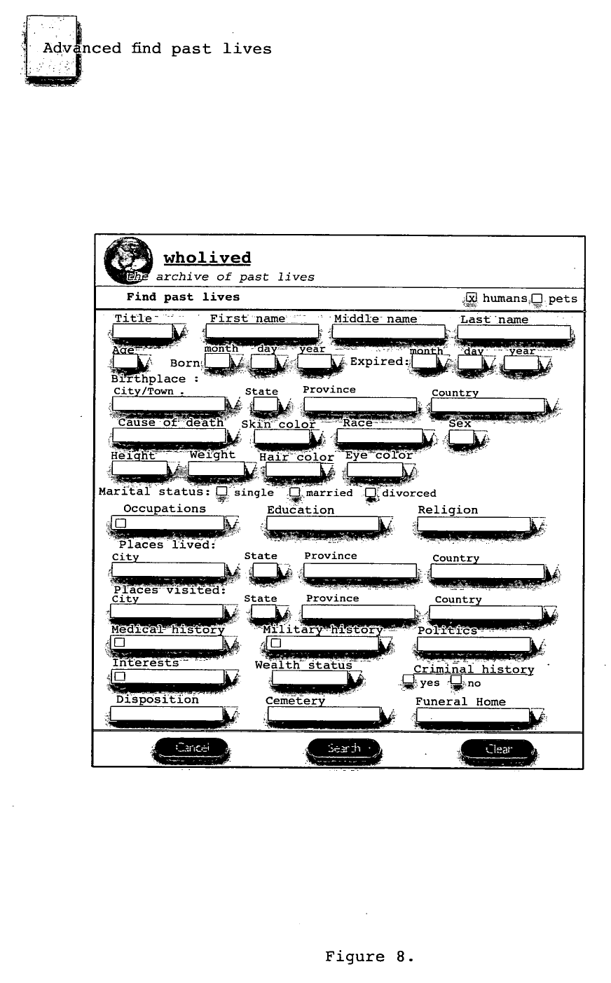

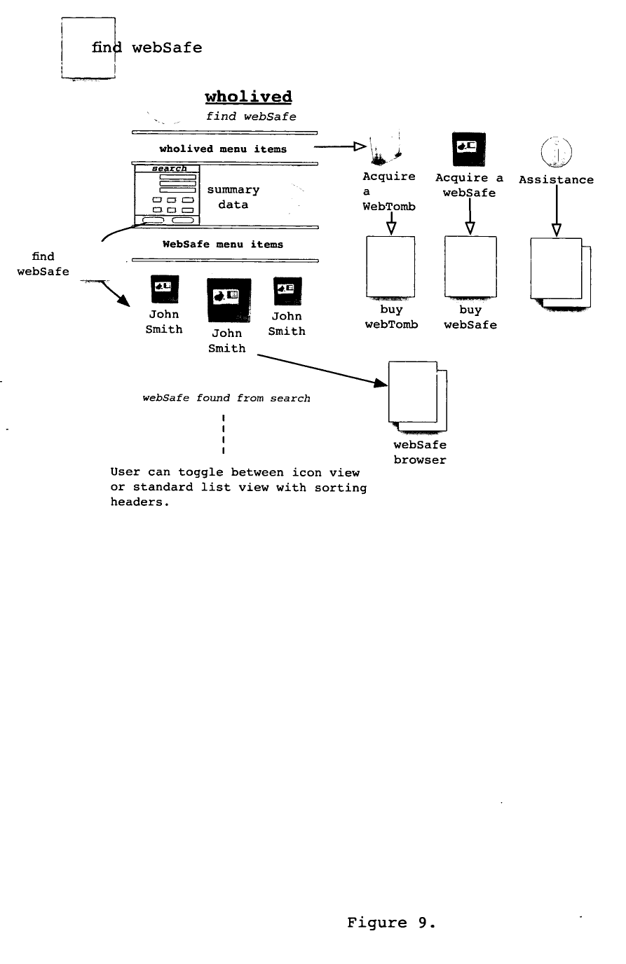

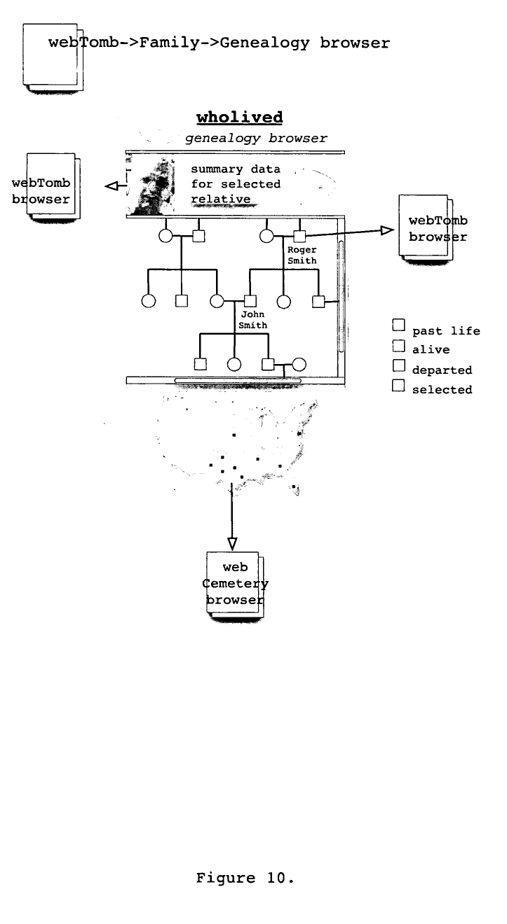

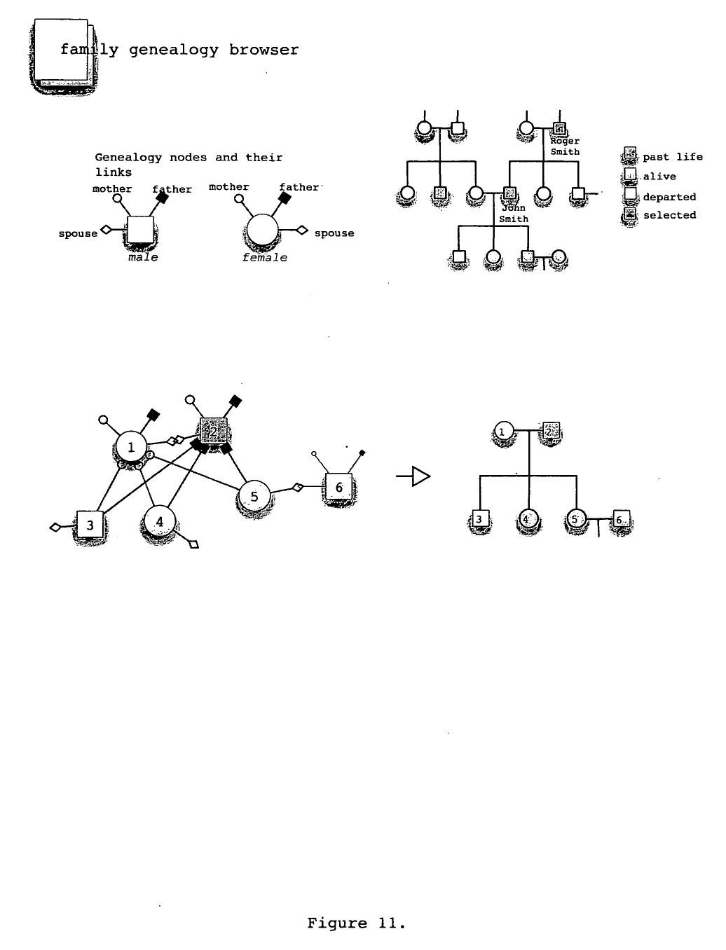

FIGS. 5, 6, and 7, show some relationships between the information stored in databases in the wholived system of FIG. 1 and the information presented in a user interface to a user of the system. Typically, the user interface includes a browser user interface to communicate information with a user of the system. FIG. 8 shows a search user interface for searching information about past lives stored in one or more databases in the wholived system of FIG. 1. A webVault, as illustrated in FIG. 9, stores information relating to a life in contemplation for when the life will end and will therefore be associated with a webTomb. FIGS. 10 and 11 show how a user can utilize a genealogy browser function of wholived system to create a family tree (or network) of past and present lives related to a particular individual of interest. The rich and vast amount of information stored in the one or more wholived databases would make the association (linking) of individuals in a genealogy network much more reliable and easier for a genealogy search function.

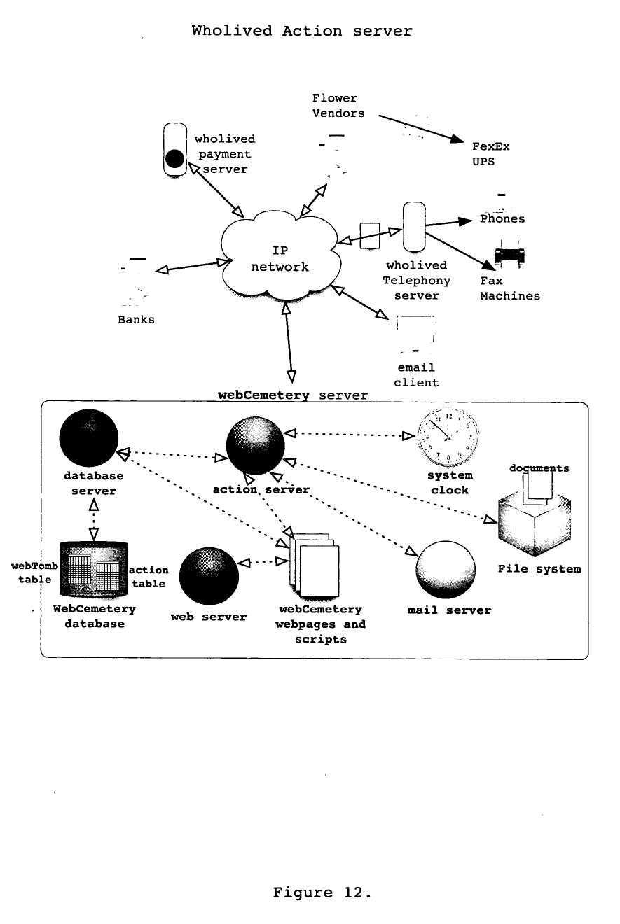

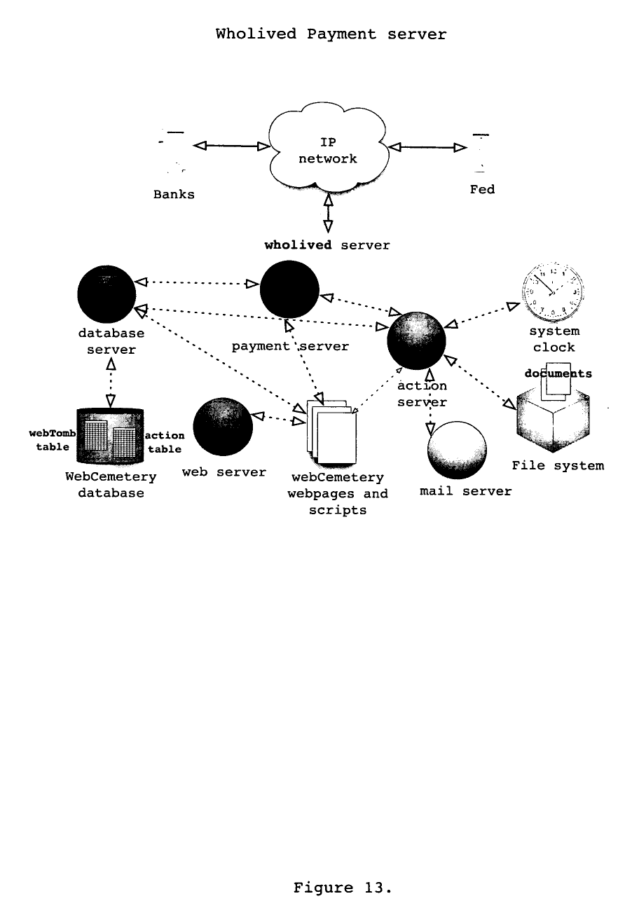

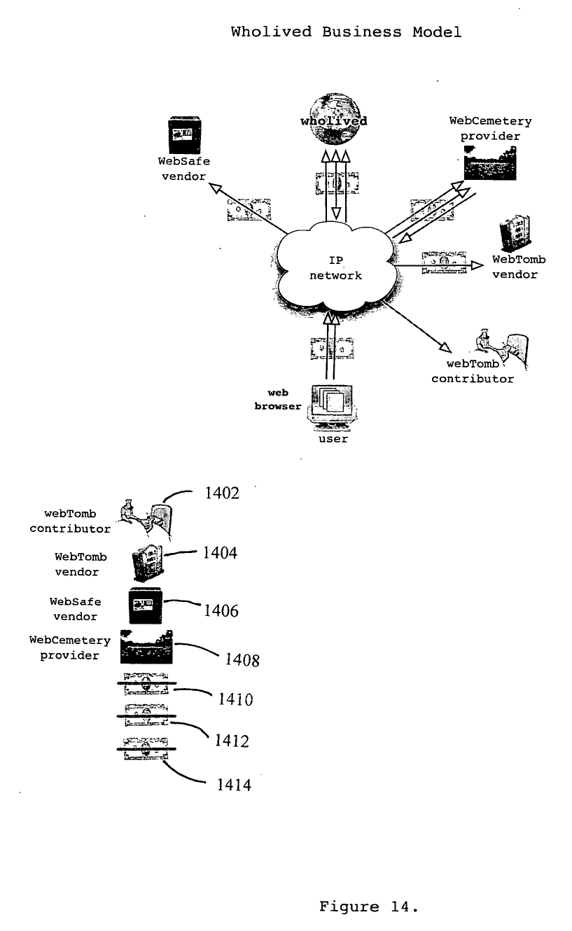

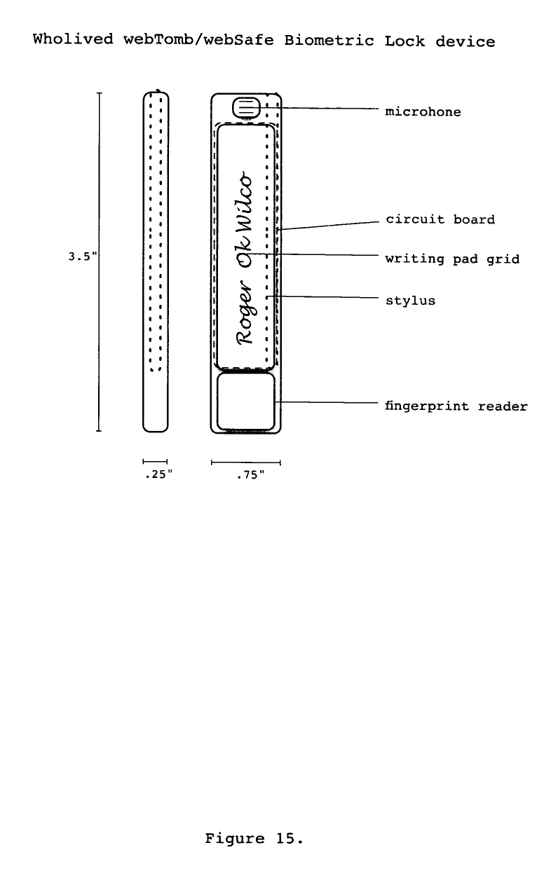

The wholived system, as illustrated in FIG. 12, can automatically activate and/or invoke actions associated with particular websafes, and also with particular webvaults and webtombs. Further, as shown in FIG. 13, payments can be handled via a server in the wholived system to allow payment actions to be automatically activated and/or invoked by the wholived system, such as for particular webvaults, webtombs, or websafes. FIG. 14 shows a high level view of communications between an exemplary wholived system and other objects (or network nodes) across a network. This network communication overview illustrates some of the system components in communication within the exemplary wholived system according to an example of a business model. FIG. 15 shows a biometric lock device that is transportable by a user such that it allows safe and secure access by the user to particular locked websafes or to locked portions of webtombs using network communication with the wholived system. The biometric lock can authenticate the user to the wholived system by sending data securely over the network to the system server. The data confirms the authenticity of the user such that a lock can open and allow the user remote access to a stored area of a database associated with a particular object in the wholived system. For example, a websafe may hold secret documents and valuable information that a user may want to add to, modify or delete, or otherwise access, in a private and secure communication prior their demise. Similarly, a webVault or a webTomb may include secure documents in a locked portion of a database that will be accessible by a user only after identification of the user by the system.

Below will be discussed certain features of exemplary embodiments of a wholived system, according to alternative embodiments of the present invention.

A wholived system can archive present and past life historical information as a global chronicle of people or pets who are living or have past on earth. It provides a dynamic model for archiving information associated with present and past lives. The information can be added to a virtual tomb (e.g., webtomb) such as by at least one agent (e.g., a web agent, such as based on executable software running on one or more agent servers on the Internet) that automatically (and/or manually) gathers information requested by the wholived system, the living owner, by system personnel, or by people who know or knew the present or past life associated with a virtual vault or tomb respectively. Additionally, if confidential, legal or estate planning information is gathered in for a future passing of a life, the information could be stored in a virtual lock box (e.g., a websafe) in their webvault or webTomb. The information could also be stored in a virtual lock box (e.g., a websafe) in their webVault. This causes the electronic storage of legal documents that can spring to action upon the death of an individual or upon other conditions being met or upon certain events occurring. These documents can be created online, then printed out and signed and notarized with a copy to a legal professional such as one's attorney. Then, the final legal document can be scanned back into the virtual lock box for safe keeping until needed after the passing of the individual. Note also that the virtual lock box (web Safe), and also the virtual vault and the virtual tomb that have lockable portions, are only accessible to persons with certain level of security. According to one embodiment, a biometric lock device could be used by a remotely located user to identify the remote user to the system with network communication between the biometric lock device and the wholived system server. The lockable portions can be as specific as an individual item, such as a will document or a trust document. Additionally, multiple custodian accounts and/or trustee accounts can be associated with a virtual safe and/or a virtual tomb and/or a virtual vault.

A virtual vault or a virtual tomb can contain computer executable instructions that are associated with instructions provided by a person associated with the virtual lock box in planning for an event, such as a time period after when the person becomes deceased. Additionally, the computer executable instructions stored in the virtual tomb may be associated with instructions provided by professionals and administrative personnel supporting and maintaining the wholived system and the virtual vault and the virtual tomb. The virtual vault, and the virtual tomb, manifests itself to cause certain actions invoked by the virtual vault, and the virtual tomb, through the computer executable instructions stored and associated therewith.

A virtual tomb and/or a virtual vault, and/or a virtual lock box (a web safe) can invoke at least one agent, (e.g., a web agent, such as based on executable software running on one or more agent servers on the Internet) that can automatically (and/or manually) monitor and search information being dynamically created and provided on the Internet. For example, a first virtual tomb can reference information that is stored and associated with a second virtual tomb. The first and second virtual tombs are not necessarily stored in the same computer system. These can be loosely coupled across a wide area network such as the Internet. The invocation of a web agent can be as a result of a particular demand from a person or an entity associated with a virtual lock box and/or a virtual tomb, and for a specific time period based on time and/or on one or more events. Additionally, the web agent can be invoked continuously searching the Internet for certain requested information that is requested by a person or an entity associated with the virtual lock box and/or virtual tomb. A clock-calendar module associated with a virtual tomb facilitates the perpetual running of scripts and executable instructions in a computer system and/or across networked computer systems.

As another example, a person can create an online will document and/or an online trust document that electronically provides instructions that can be automatically invoked by the virtual tomb, for example, after the person passes away, or provides instructions to persons or entities that can then fulfill the instructions and wishes expressed in the will document and/or the trust document. The automatic invocation of instructions can include actions to notify a pre-selected or pre-defined custodian of the will or a pre-selected or pre-defined trustee of the trust, and additionally can notify and provide information to a professional such as a legal professional or a financial professional, can cause communication of financial information that can include transferring money between bank accounts, transferring securities between securities accounts, and executing financial transactions of many different kinds. For example, the instructions can cause the purchase of all types of goods and services. These mechanisms as discussed above can provide an estate planning tool and a will and/or trust document implementation assistance for people planning for the passing of a life. Additionally, multiple custodian and/or trustee accounts can be associated with a virtual safe and/or virtual tomb and/or virtual vault. These multiple custodians and/or trustees can be organized in a hierarchy or a list such that automatic notification and roll-over authorization of individuals in an orderly fashion is automatically effected by the virtual tomb when necessary.

The virtual tomb, vault or safe can also send messages or effect certain transactions under a set of ongoing rules and conditions. As a first example, reminder messages can be sent to people to cause certain activities that are part of the instructions of an online will and/or an online trust. As a second example, upon the passing of a husband, the online will and trust instructions that are invoked by the virtual tomb can cause recurring events such as sending happy birthday email messages and/or cards and/or sending flowers at certain times to loved ones, such as a wife or children of the deceased. However, the recurring events can be limited to only at certain times and only while the target person for receiving the goods and/or services is alive. That is, the virtual tomb or vault can invoke a web agent that monitors for information about the passing of a certain individual. While the individual is alive, the virtual tomb or vault can cause recurring events as discussed above. However, after the passing of the certain individual the virtual tomb or vault can cause a stop of the previously one or more recurring events and/or can cause one or more different recurring events to be invoked.

A virtual safe can monitor tax tables, can compute tax on certain financial assets, and can automatically cause the transfer of monetary funds to a tax account such as an IRS tax account to pay required taxes. Further, a data message and optionally a telephonic pre-recorded voice message or fax message can be sent to authorize actions by service providers, such as attorneys, accountants and other professionals. The telephonic voice message can be played back to a called party to authorize actions.

Additionally, a virtual cemetery, that can represent a collection of associated virtual tombs, can be browsed by a web browser in a manner such as to provide a virtual walkthrough of the virtual cemetery to a user of the web browser. Additionally, the web browser can browse through (and virtually walk through) one or more virtual cemeteries all over the earth. The user can select which one or more virtual tomb to view in more detail after locating them during the walkthrough. A topology map can provide visual information to a user of the web browser to allow the user to walkthrough one or more cemeteries. The virtual cemetery could visually, and graphically, as well as audibly and even tactually, can represent at a user interface the representation of an actual cemetery where, for example, an individual is buried in an actual tomb. Besides seeing pictures of the cemetery, the user interface can provide audio information such as the sound of the wind and other sounds associated with the actual cemetery. Tactual information such as from a rumble pack or other vibratory device can provide sensation of movement and contact with objects that are associated of the visual representation of the actual cemetery at the user interface. A virtual tomb can be visually located on a map of a virtual cemetery that represents an actual physical cemetery. The coordinates of the actual tomb could be stored in the virtual tomb, such as GPS coordinates or other grid coordinates provided by the administrative personnel for tracking the actual cemetery.

A virtual tomb can provide a facility for creating a reunion experience for people related to the deceased associated with the virtual tomb. Text, audio, video, and other information can be real time provided from a data repository and sent to one or more individuals that are sharing a common communication event with the virtual tomb. The individuals can also be entering information into the repository that then makes the entered information available to all the individuals sharing the reunion experience. The virtual tomb can also provide pre-stored information to all the individuals. For example, a pre-recorded video and audio message from the deceased can be sent to all the individuals at a reunion event. Additionally, live individual using a web browser or computer device can engage in a chat with an occupant of a tomb associated with a virtual tomb. The pre-recorded information at the virtual tomb can monitor received messages from the live individual and determine by executable instructions what appropriate message or information to provide in response to the received message. For example, a declarative statement can be acknowledged. An interrogatory statement can be answered with pre-stored information or optionally triggering a web search for the requested information that is then provided to the live person asking the question.

A collection of linked virtual tombs and vaults can provide a base for creating and maintaining a genealogy map of a family. Additionally, virtual tombs and vaults can automatically heuristically self-link to other virtual tombs or vaults upon the passing of other people that are associated with new virtual tombs. It can also automatically heuristically self-link to other past lives that are recorded in other databases available on the wide area network such as the world wide web. In this way, a search back to create links with past relatives as well as a continuous linking forward with future deceased family members creates a dynamic genealogy mapper system that is available in an embodiment of a wholived system. This genealogy mapper is useful not only for humans to find and track their family tree, but also for owners of animals such as breeders who want to keep track of for example champion blood line for dogs, horses, etc.

Relational Linkages of Common Information between Multiple WebTombs or WebVaults

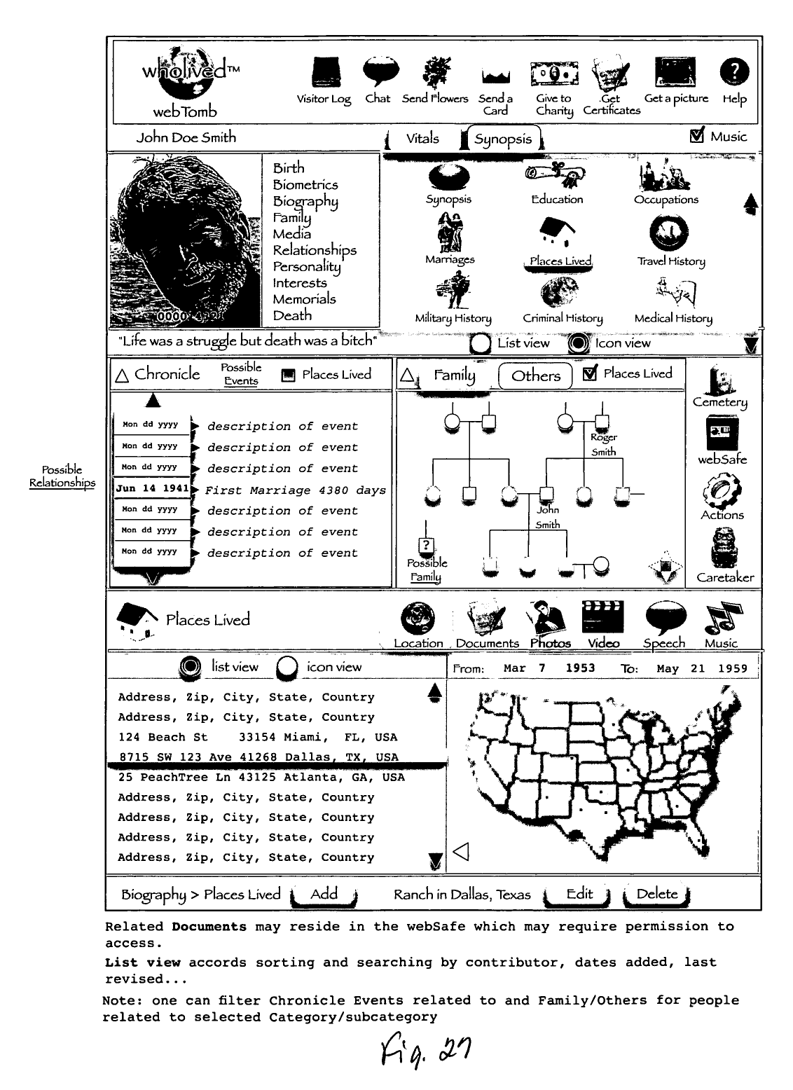

For example: a user adds a photograph to a webVault or webTomb pertaining to a birthday party for the occupant. He/She defines the associated event (e.g. 31st birthday), and associates it with the category biography->birthdays, and specifies the date and time and geographical location of the birthday party, and specifies the Family and Friends in the photograph, then saves the photograph. Once saved, wholived (such as using a linkage search agent in the wholived computer system) compares the specified Family involved against other wholived occupants that share the same name and other heuristic information. For example, a shared date and time and geographic location of an event may be found, or a commonly shared information may be determined, or a shared family member or family relationship may be found or determined, or a shared friend may be found, or any shared relationship between a life, past or present, and each of the different webtombs and/or webvaults being compared. When a possible match is found, wholived (such as the linkage search agent and/or a wholived computer server) notifies each matching webTomb or webVault (e.g., notifies the custodian or caretaker thereof) that a possible family link (e.g., a shared family member and/or a shared family relationship) exists and requires validation for incorporation. See FIG. 27 for possible event exists annunciator in the Chronicle dialog and for possible family exists and possible relationship exist annunciators in the Family Genealogy dialog. The alert can take the form of a screen display prompt including displaying to the custodian the information, and optionally also includes an audible prompt, to the custodian to approve or reject the link and the incorporation of the information in the matching webTomb or webVault associated with the custodian. In response to receiving an approval by the custodian, the wholived computer server can store the information in the collection of information associated with the particular webTomb or webVault associated with the custodian.

In this way, the Family Genealogies of the occupant's of webVaults and webTombs can grow dynamically. The more occupants of wholived that exist the faster the dynamic growth of the Genealogies.

Wholived may also relate webTomb and webVault occupants by shared common events. Wholived finds all occupants that have an event defined that occurred at identical dates and times and at the same geographical location(s). Wholived notifies all matching webTomb or webVault custodians and owners that possible shared events exist that require validation for incorporation. This notification can be made in many different ways, such as by any one or a combination of the following: by email message, by a built-in function in the wholived system computer server that presents the message (such as in a display) when accessed by a user, by sending a fax document, by placing a telephone call and playing back a recorded message, and the like. Once incorporated, all the media associated with the event belonging to all occupants involved is accessible to each of the participants involved in their webTombs or webVaults.

In this way, the Information associated with the life history of the occupant of a webVault or webTomb can grow dynamically.

In various exemplary embodiments of the present invention, the stored collection of information associated with each of the webtombs and/or webvaults can be organized by specific information associated with
a category or type of information, and
one or more events in the life, past or present, represented by the each webtomb or webvault, respectively, each event being associated with
a category or type of event,
a date and time of occurrence of the event,
geographic location or locations of occurrence of the event,
family involved in the event,
friends involved in the event,
any other life, past or present, involved in the event, and
any combination thereof.

According to exemplary and non-limiting embodiments of the present invention, various examples of a wholived computer system will be described below. The computer system, according to the present example, can provide user access to a collection of webtombs, or webvaults, or both and any webSafes contained therein. The computer system comprises at least one computer server communicatively coupled with at least one communication network. The system also includes at least one database, communicatively coupled with the at least one computer server, for storing a collection of information organized as a plurality of webtombs and/or webvaults, each webtomb being associated with a collection of information representing a past life and each webvault being associated with a collection of information representing a present life. A web browser interface in the system is communicatively coupled with the at least one database and the at least one computer server for providing remote access to the stored collection of information organized as the plurality of webtombs and/or webvaults from a remote web browser communicating with the at least one computer server from across the at least one communication network. A user can use the remote web browser to remotely access such stored collection of information organized as the plurality of webtombs and/or webvaults.

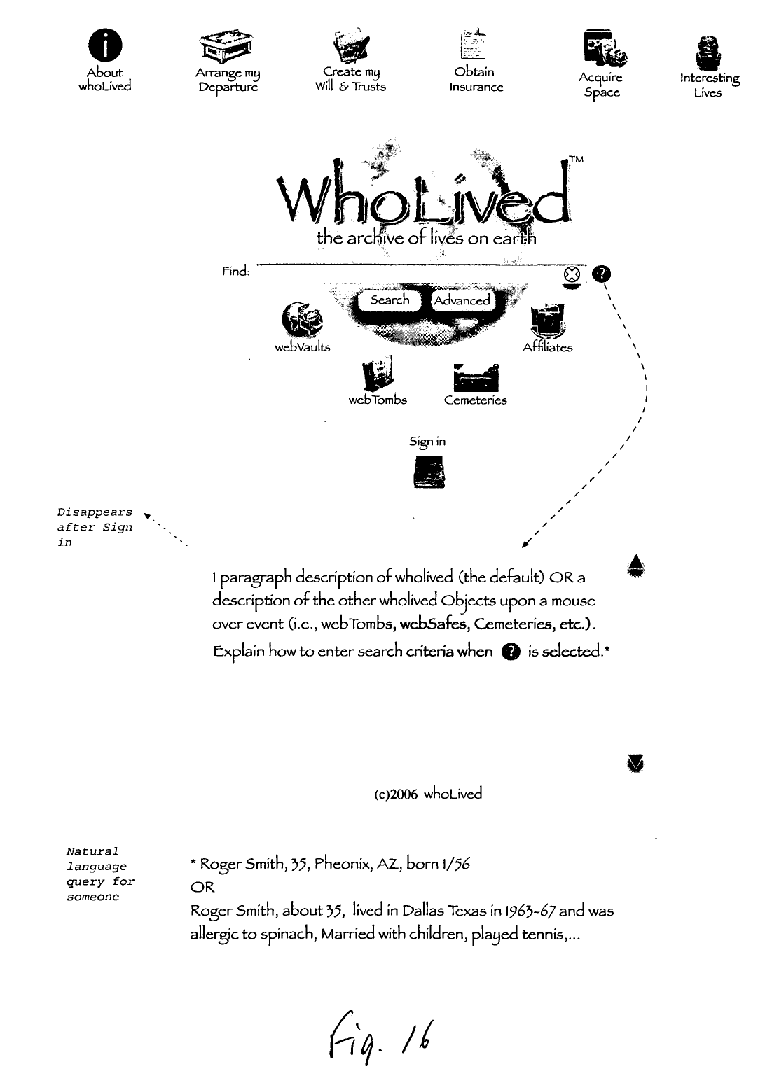

An exemplary wholived website is depicted in FIG. 16 and will be described below by a non-limiting example.

FIG. 16

An exemplary wholived home page, such as www.wholived.com is shown.

Wholived, according to this example, enables the user to search for living or deceased humans or pets and view and manage their associated information.

Wholived stores all the historical information relating to a person/pet in their webVault (if alive—a present life) or webTomb (if deceased—a past life).

Queries for people/pets return webTombs and/or webVaults that match the search criteria.

The user may select an icon (hyperlink) to perform an activity or enter a name and any other data about a person or pet to search for.

Search Criteria may be entered to find a living or departed life (human or pet). Any data comprising a webVault/Tomb's Vital Information can be entered.

Example: John Quincy Smith, born 1821, died 1887.

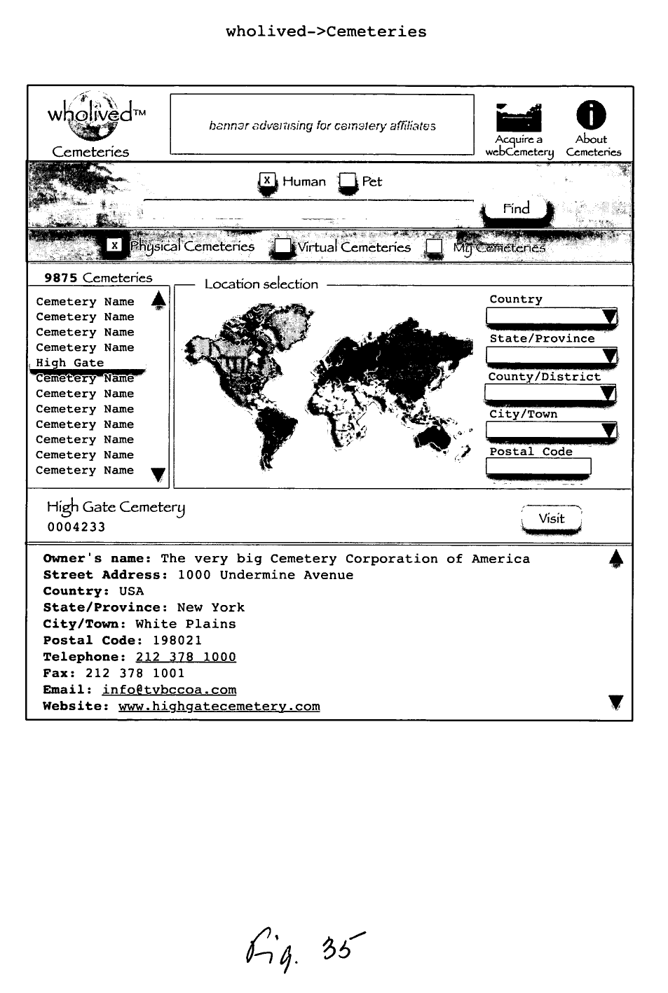

More advanced searches are available by selecting the (Advanced) button. See for example FIG. 35.

Note that, in this example, webSafes are not accessible from the wholived home page, while they can be accessed once a webVault or webTomb has been specified and opened.

Icons

About wholived—link to description of wholived

Arrange my Departure—link to description of wholived services such as acquiring webVault/Tombs and webSafes, making Funeral arrangements, Creating wills and trusts, etc.

Create my Will and Trusts—link to Will and Trust creation forms

Acquire Space—link to purchasing of webVault/Tomb or webSafe and additional space

Interesting Lives—search results for canned searches of wholived like politicians, actors etc.

webVaults—opens a list of webVaults found page if data is entered and more than one webVault is found. If only 1 webVault is found it opens a webVault browser for that webVault. If selected and no data is supplied then opens a description of webVaults page.

webTombs—opens a list of webTombs found if data is supplied and more than one webTomb is found. If only 1 webTomb is found it opens a webTomb browser for that webTomb. If selected and no data is supplied then opens a description of webTombs page.

Cemeteries—opens Cemetery list page if no data entered or more than one cemetery found when data is supplied. If only 1 cemetery is found when data is supplied open a Cemetery browser.

Affiliates—open Affiliates list page.

Sign in—enables the user to sign in and open their webVault/Tomb browser. Creates webVault for the user if it does not already exist.

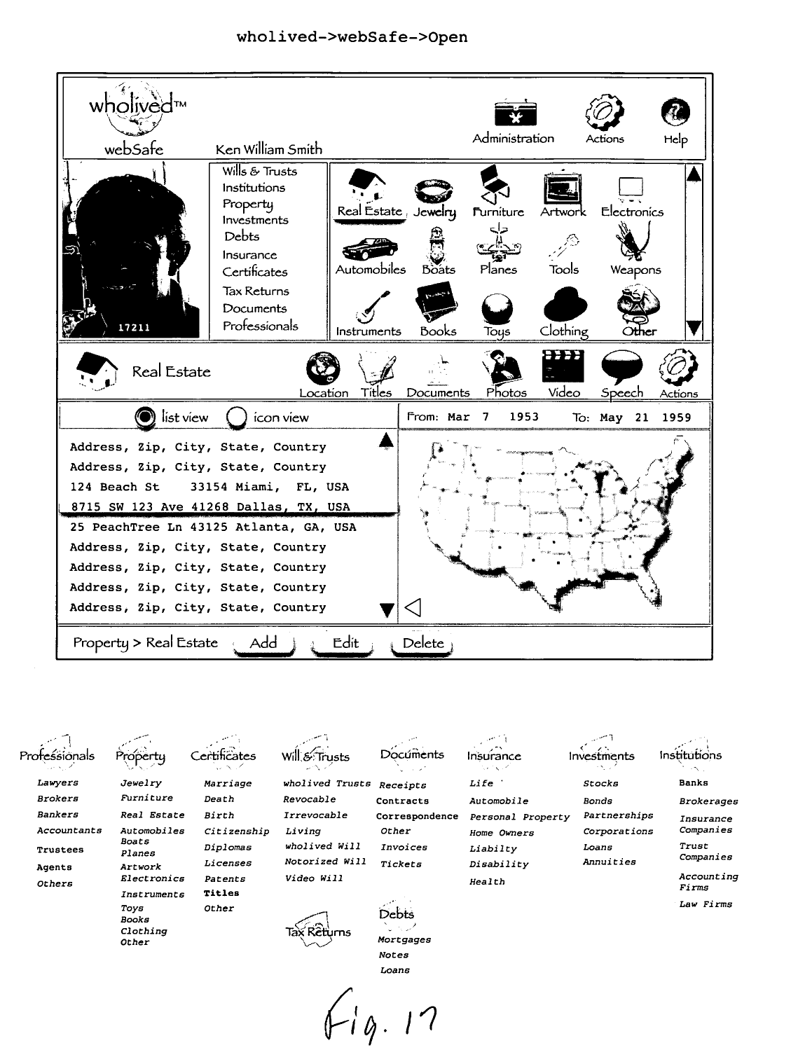

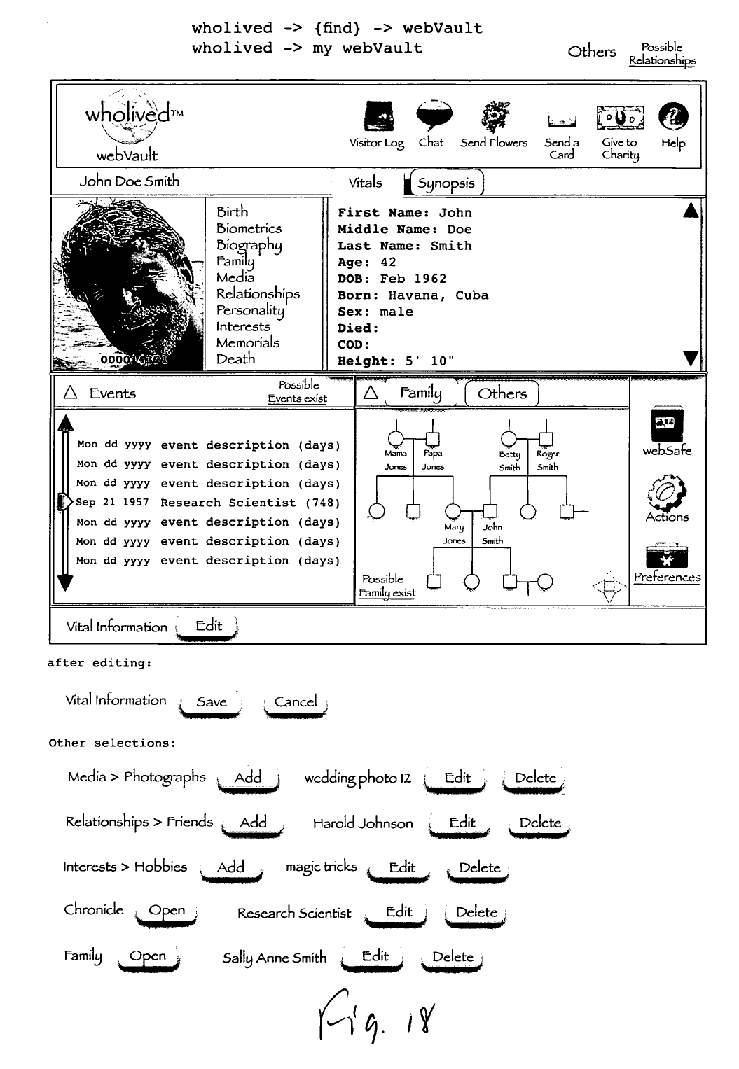

Wholived Sign in scenario is depicted in FIGS. 17 and 18, and will be described below by non-limiting example.

FIG. 17

Wholived homepage www.wholived.com

When the sign-in icon is pressed the user is prompted to enter their email address and password, or to create a new account.

Account creation consists of a dialog page that asks the user to enter Vital information about themselves. This action creates a webVault with limited space if it does not already exist.

Once sign in is complete, wholived opens a webVault/Tomb browser for that person's webVault/Tomb OR open a webTomb list page if custodian of more than one webTomb.

FIG. 18

Wholived homepage www.wholived.com

Once signed in, the wholived homepage changes with the addition of Icons:

Sign-out

Preferences—user definable parameters governing the operation of wholived for the user to customize

My webVault—open webVault browser with user's webVault if any

My webTombs—open webTomb browser with user's (as custodian) webTomb OR opens webTombs list page if custodian of more than one webTomb.

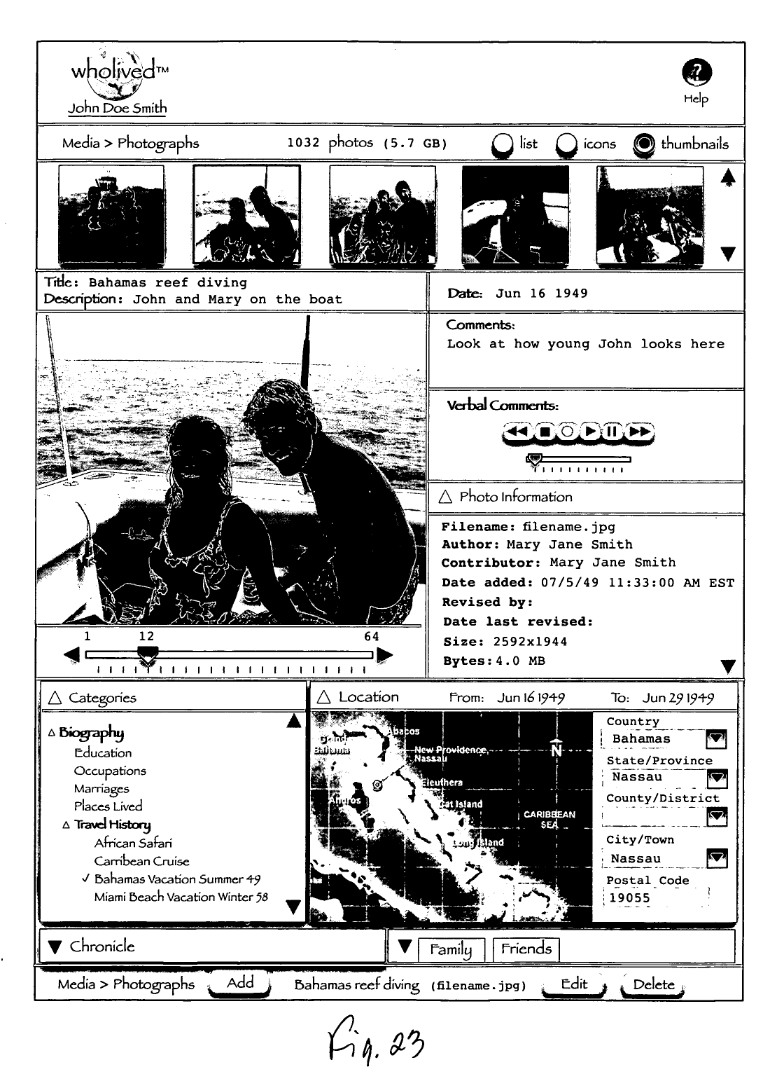

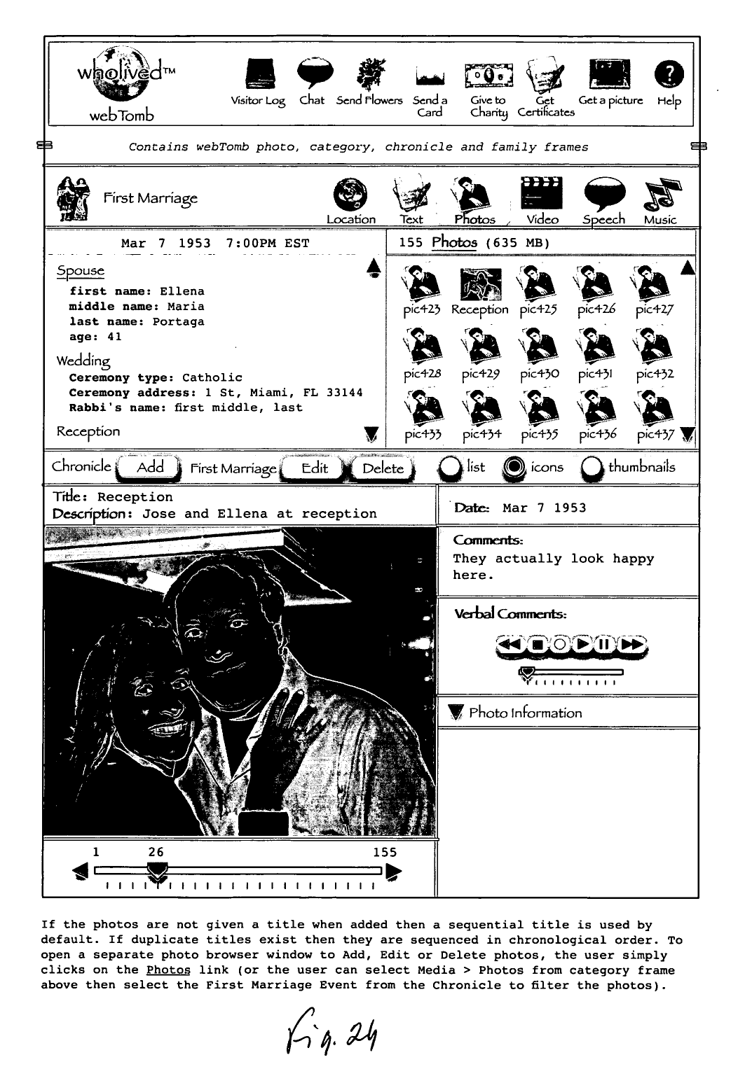

Search Results page resulting from data entered or from an Advanced search is depicted in FIGS. 23 and 24, and is described below by non-limiting example.

FIG. 23

Wholived->Search

Wholived->Advanced

WebVault/webTomb list page is displayed when data is entered or (Search) button was selected on wholived home page to perform a query OR when wholived->(Advanced) page was used to query wholived.

Icons

Acquire a webVault—opens a description of webVaults and its features and services page

Acquire a webTomb—opens a description of webTombs and its features and services page

Acquire a webSafe—opens a description of webSafe and its features and services page

Help—How the page works

User enabled to search for other people by name OR selection from list of matching people from query. The people found matching the query may be presented as a list or as a set of icons. List view enables sorting by Vital information parameters.

Vital information and biographical synopsis about the selected webVault/webTomb is displayed along with its location on the map.

webTombs/webVaults in the list may be further filtered by geographical location by selecting areas on the map

A webTomb/webVault browser of the selected webTomb/webVault is opened when the (Open) button is selected

The user may open a webCemetery browser of the associated webCemetery if any is specified by selecting the (Visit) button.

FIG. 24

Wholived->Search

Wholived->Advanced

Search results

Same description as FIG. 23 but list view is displayed. Note sorting of people/pets by Vital information parameters is possible by selecting parameter headings and choosing sort order.

Selecting the (Advanced) button on the home page opens an Advanced search page that is depicted in FIG. 35 and will be described below by non-limiting example.

FIG. 35

Find webTomb or webVault occupants that match advanced search criteria.

(Advanced) button

A webTomb or webVault Query page is displayed that contains a

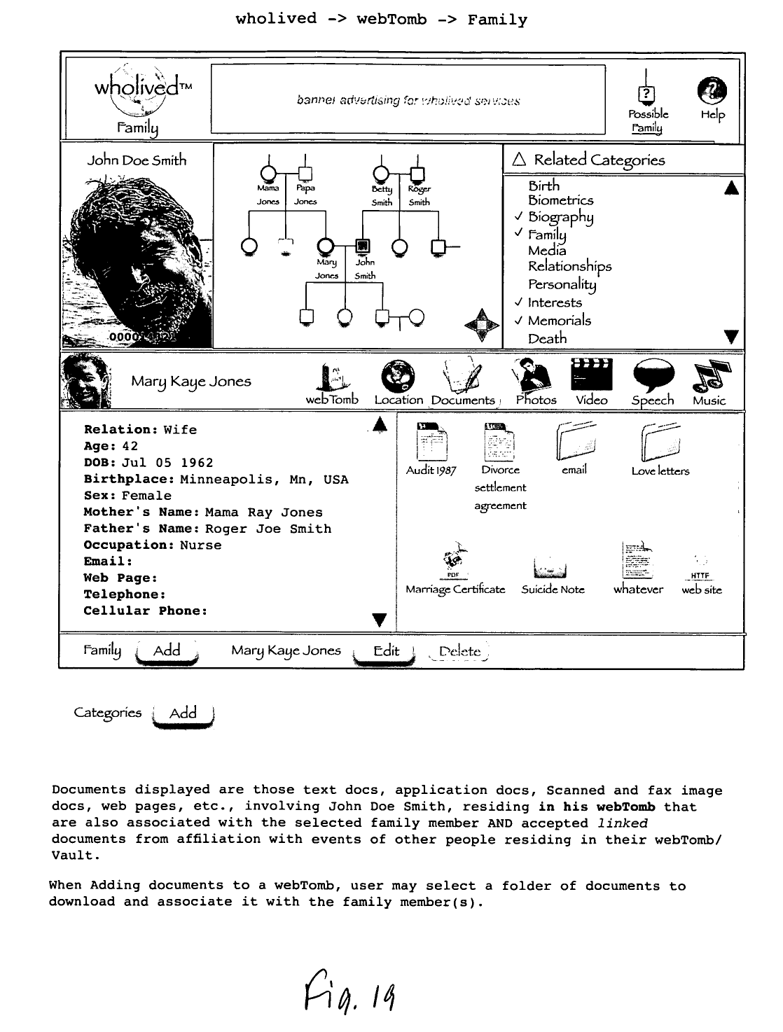

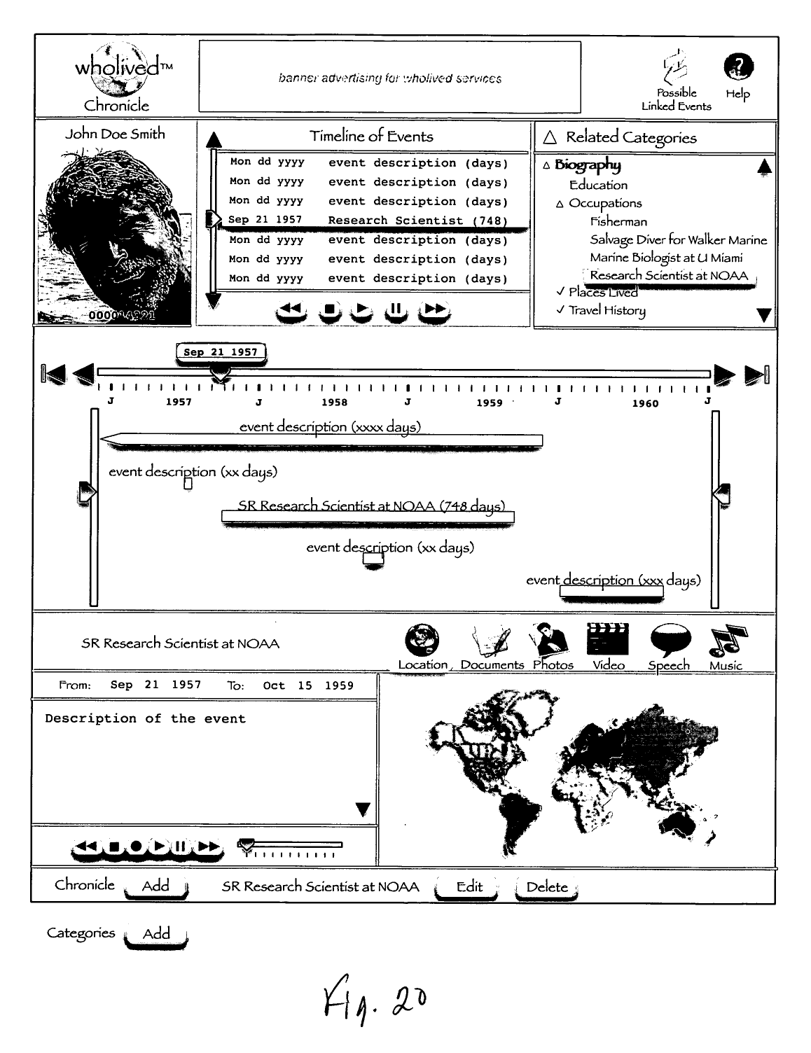

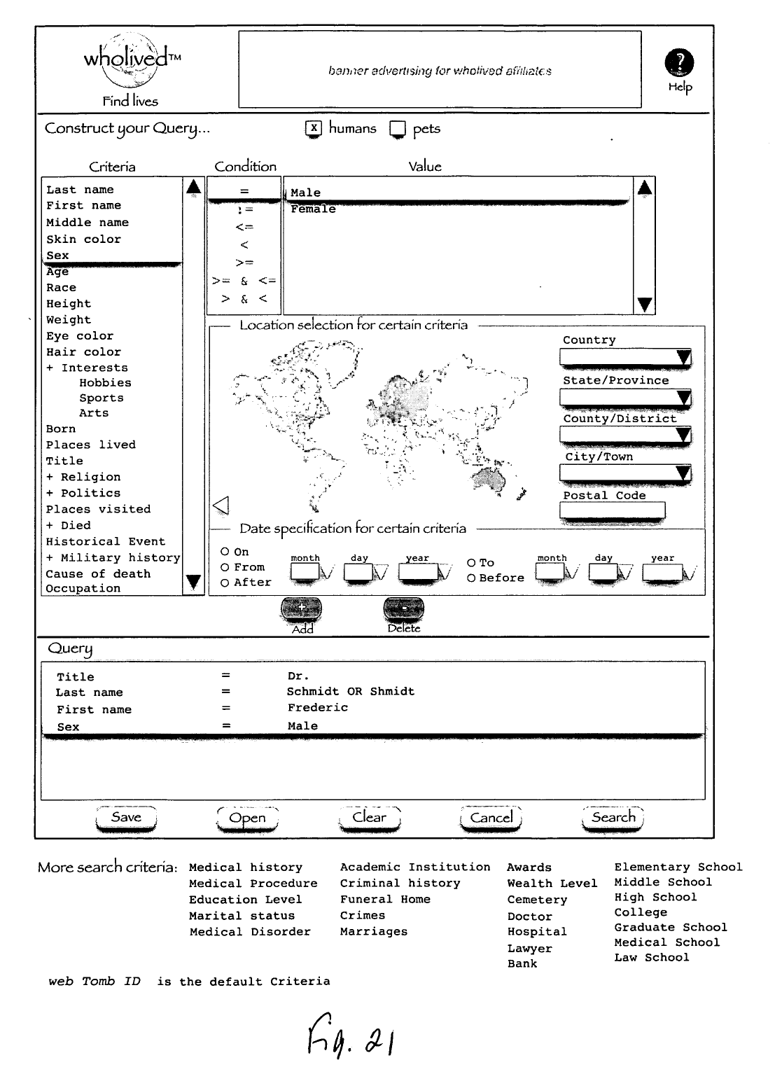

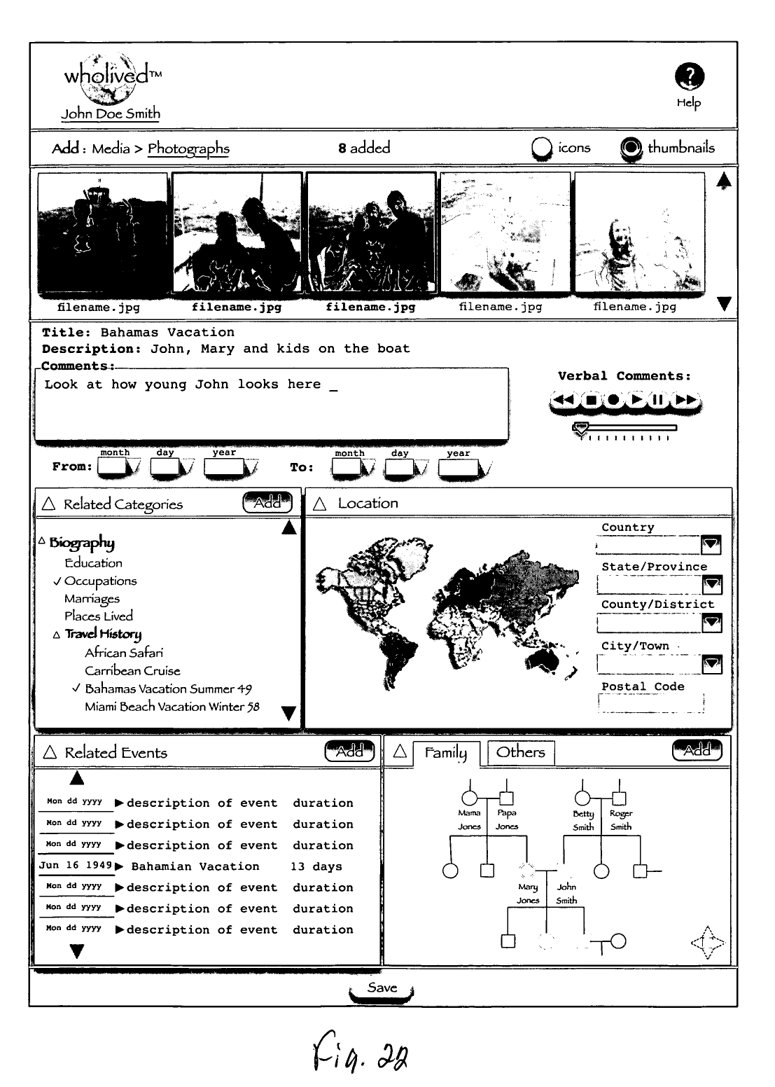

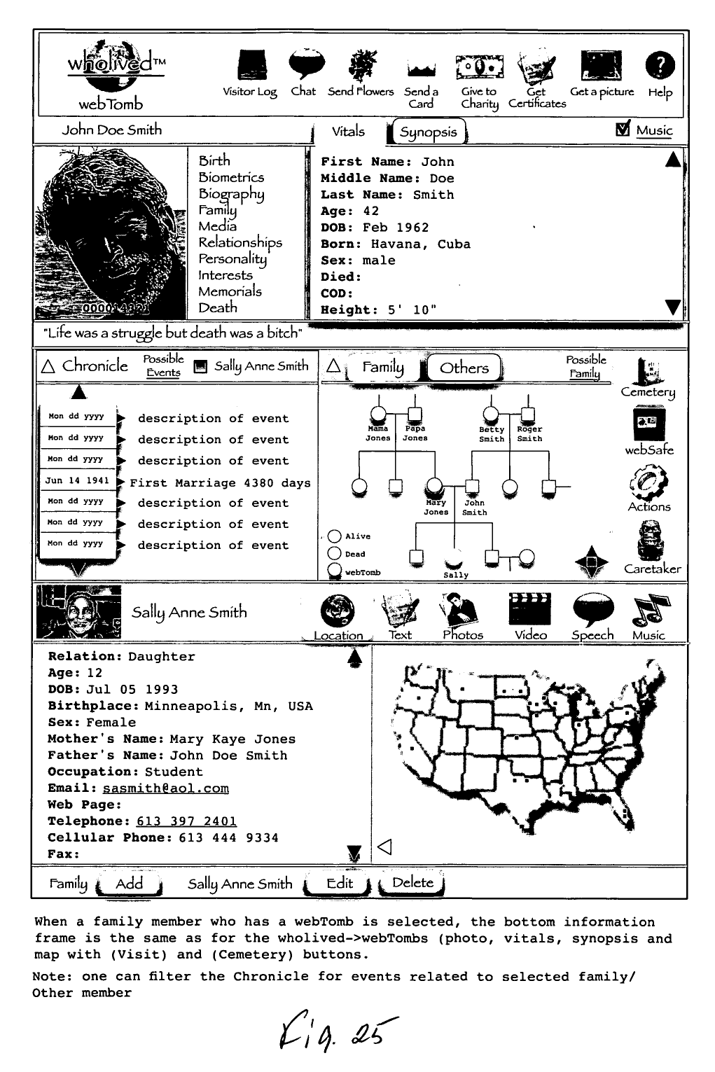

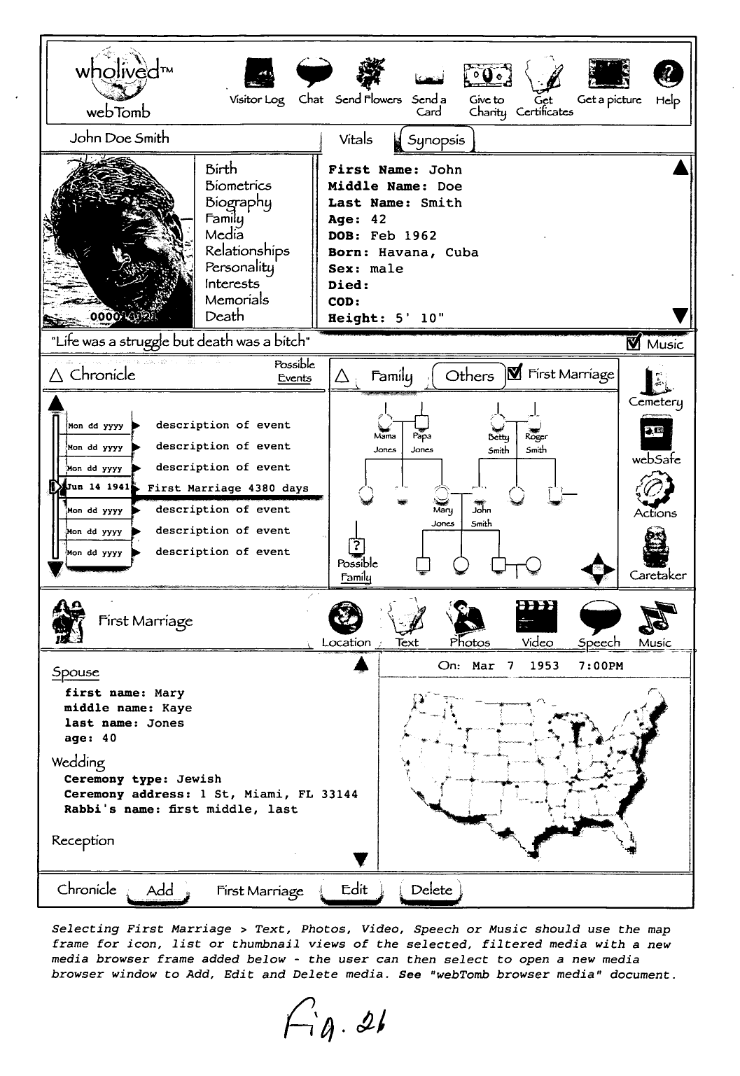

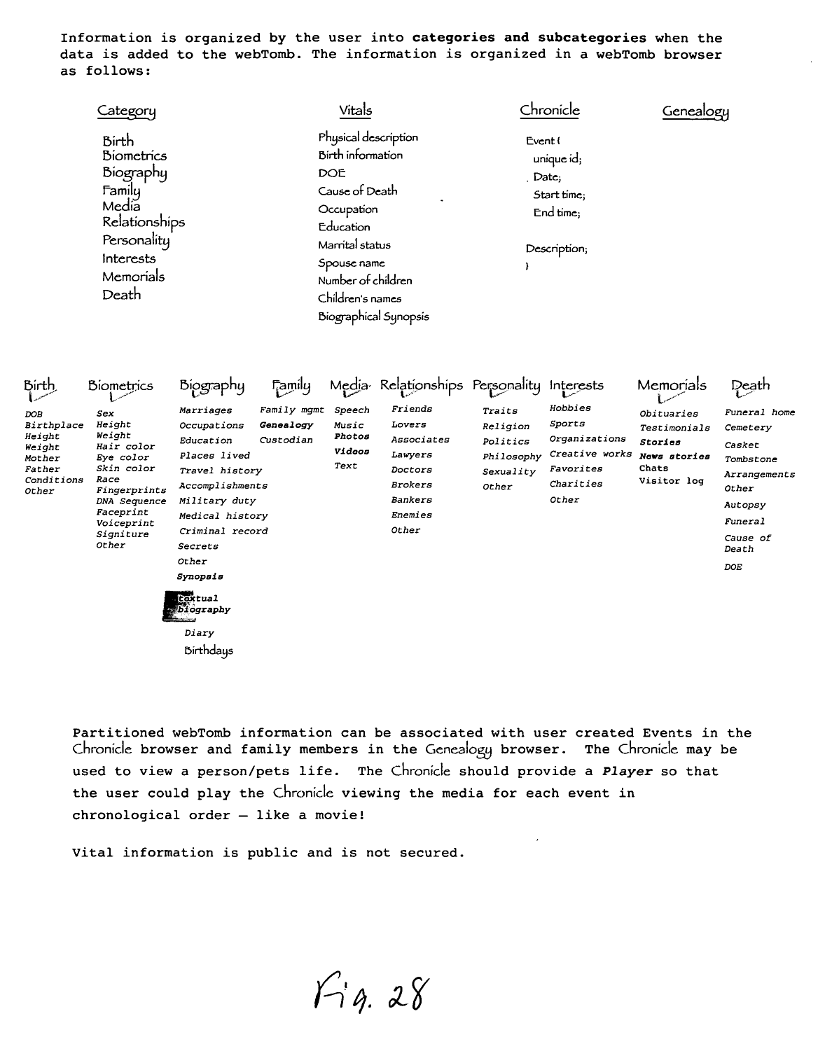

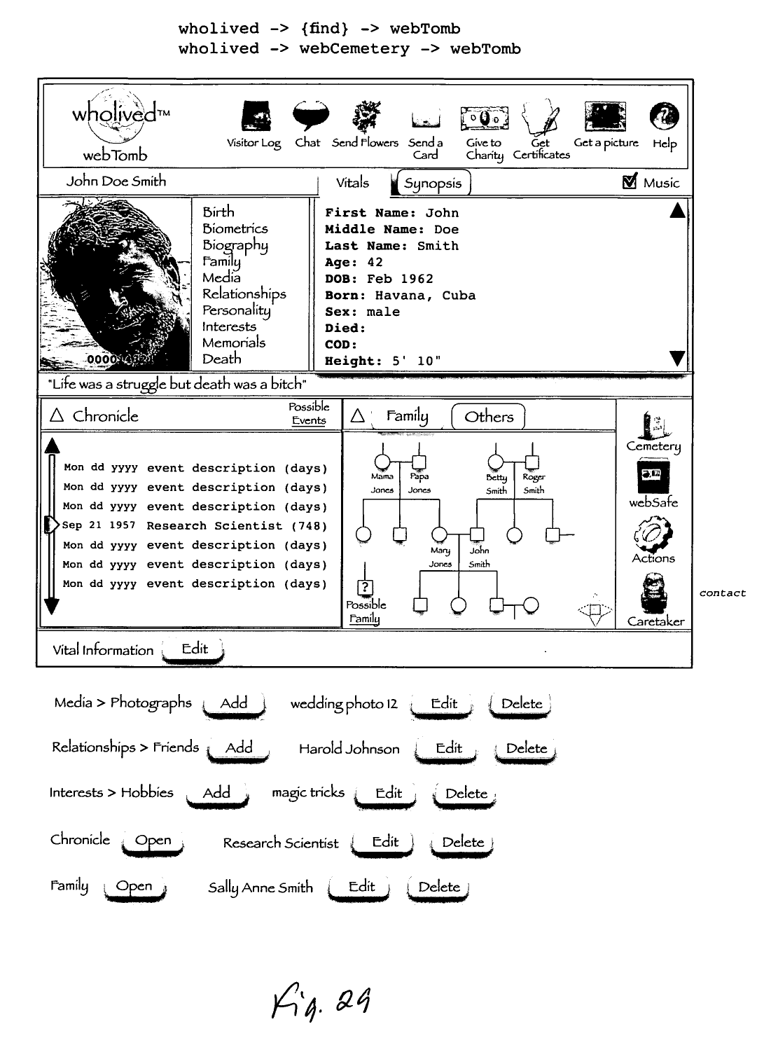

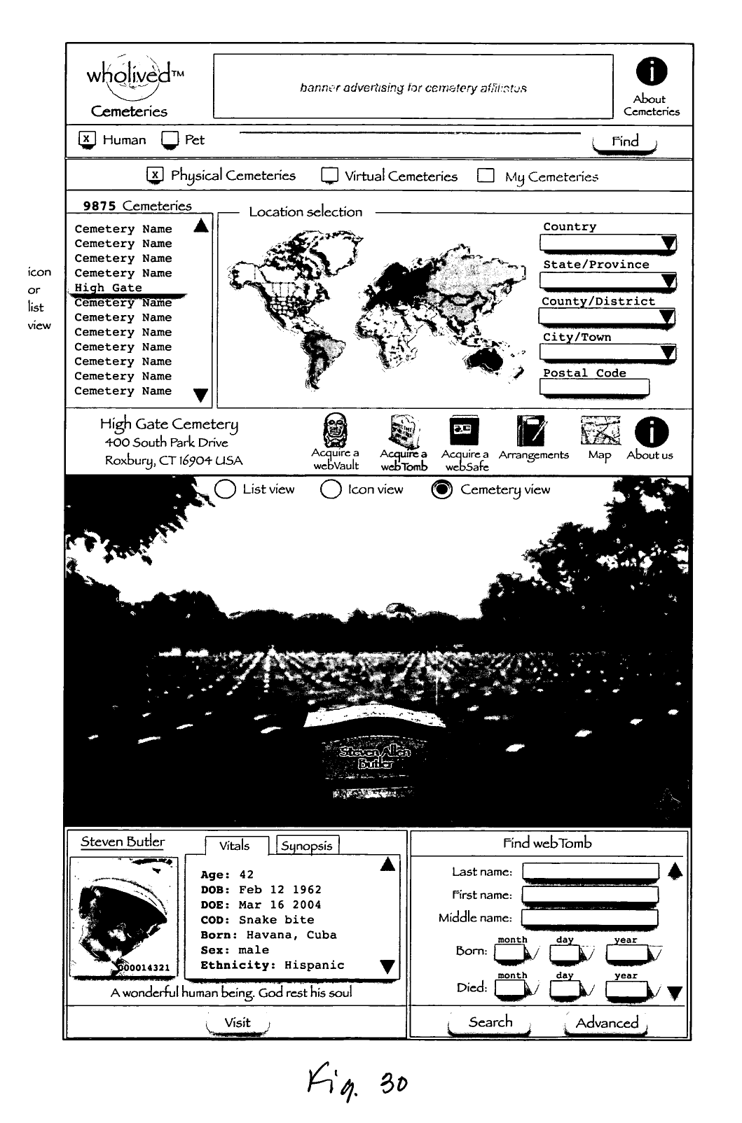

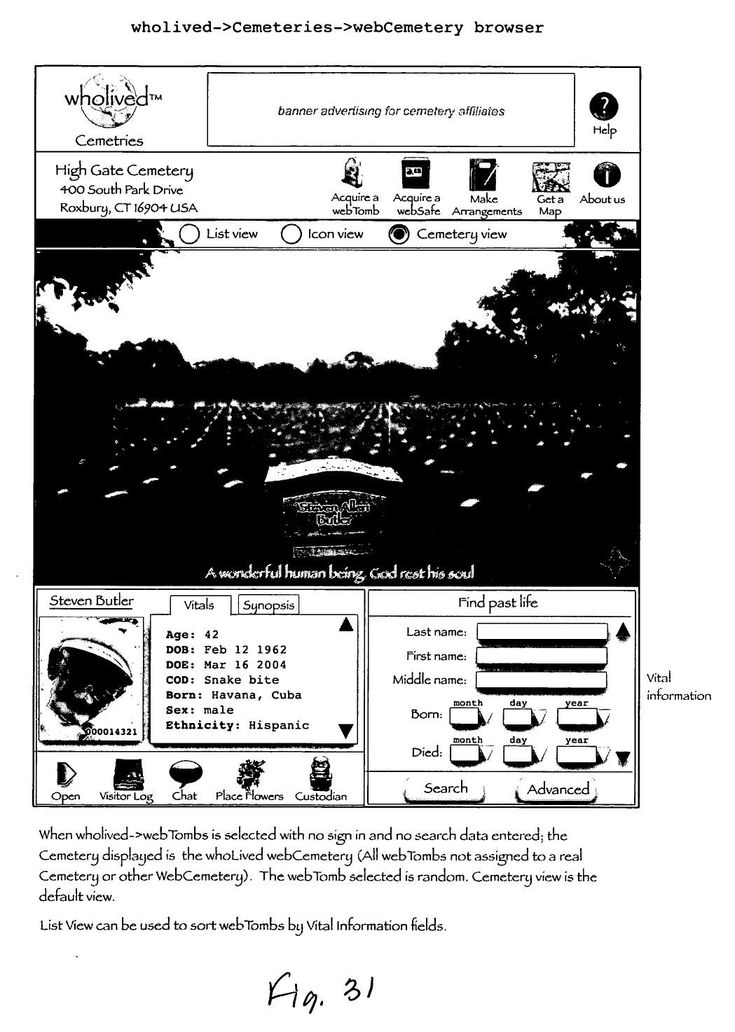

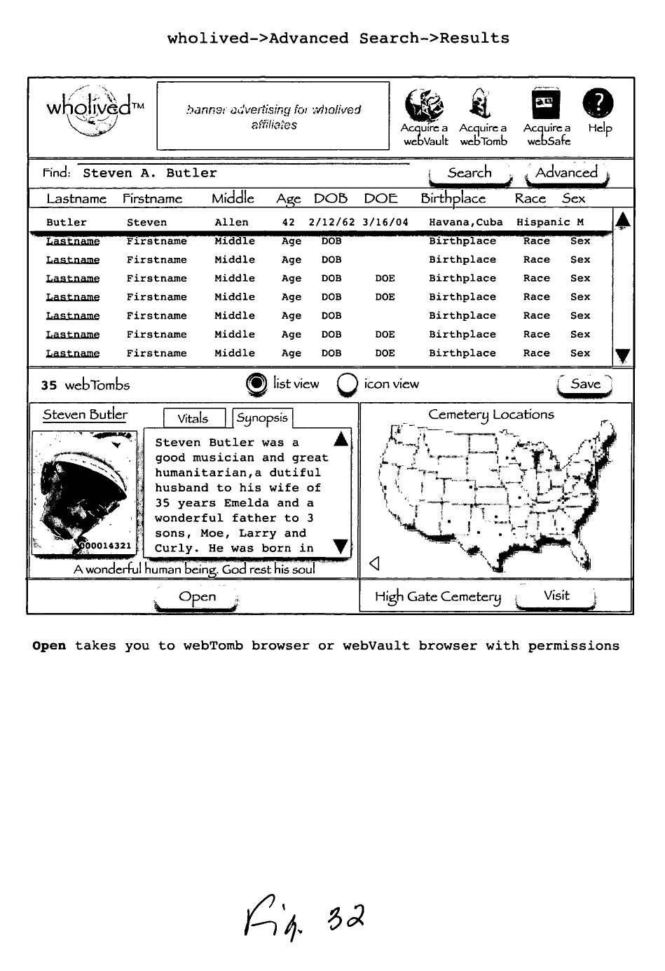

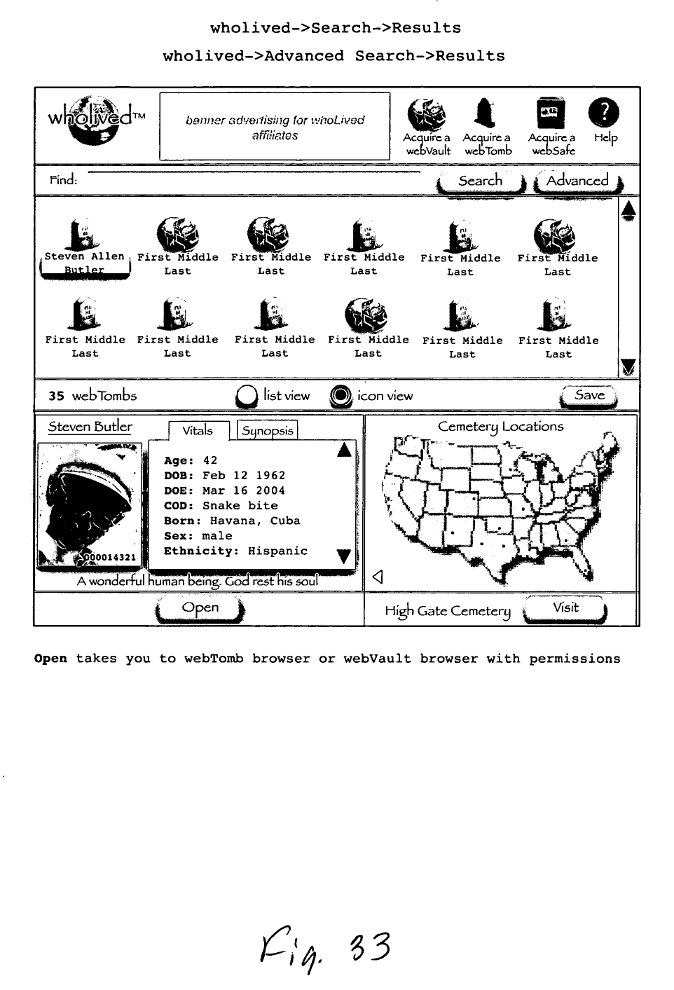

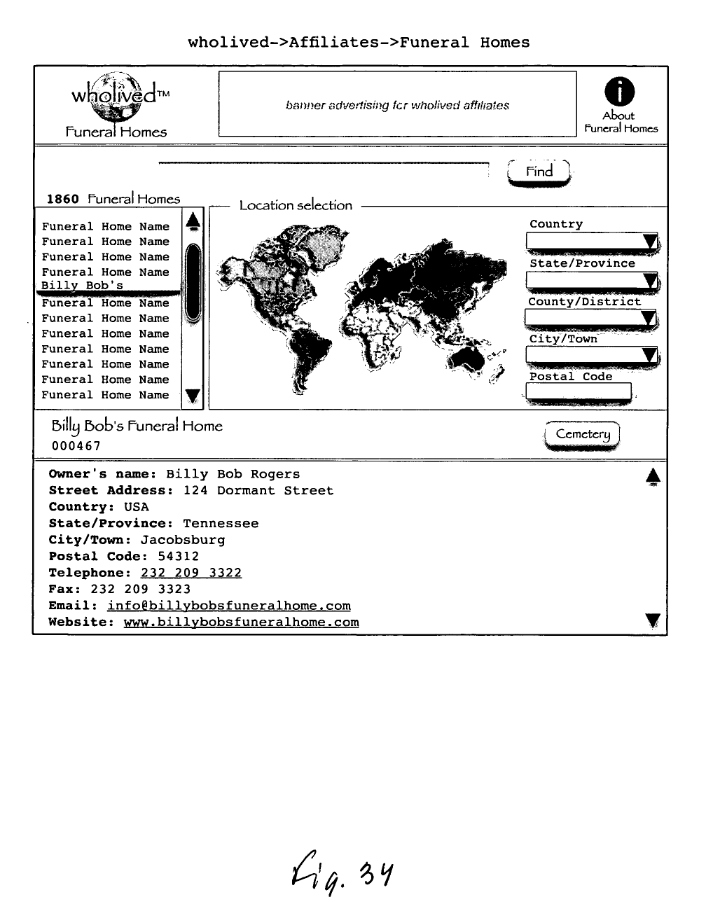

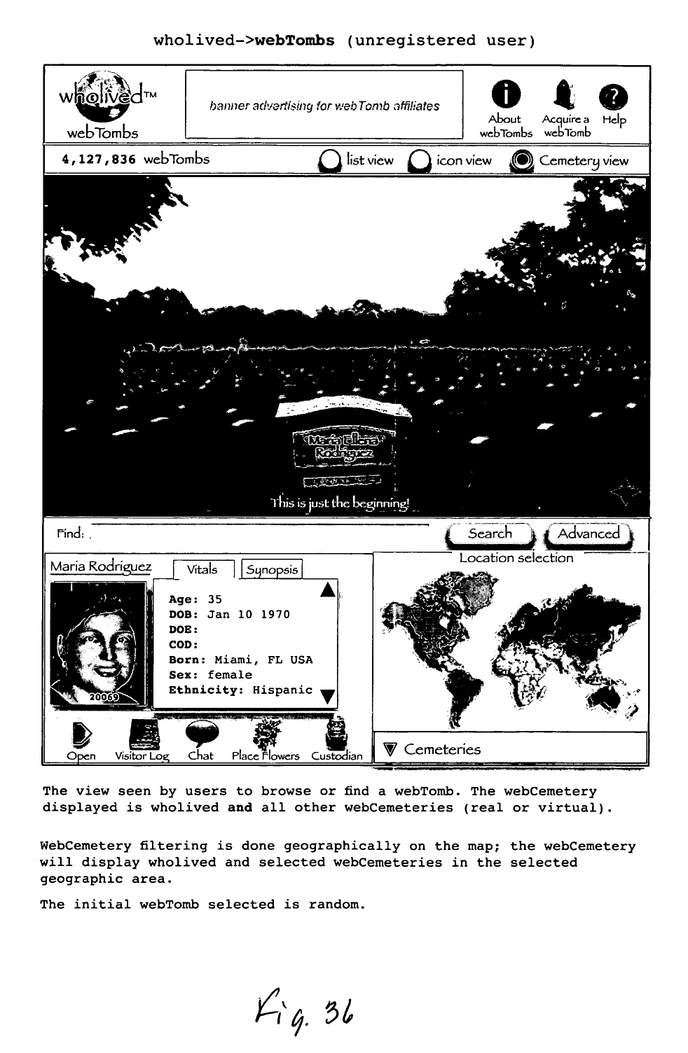

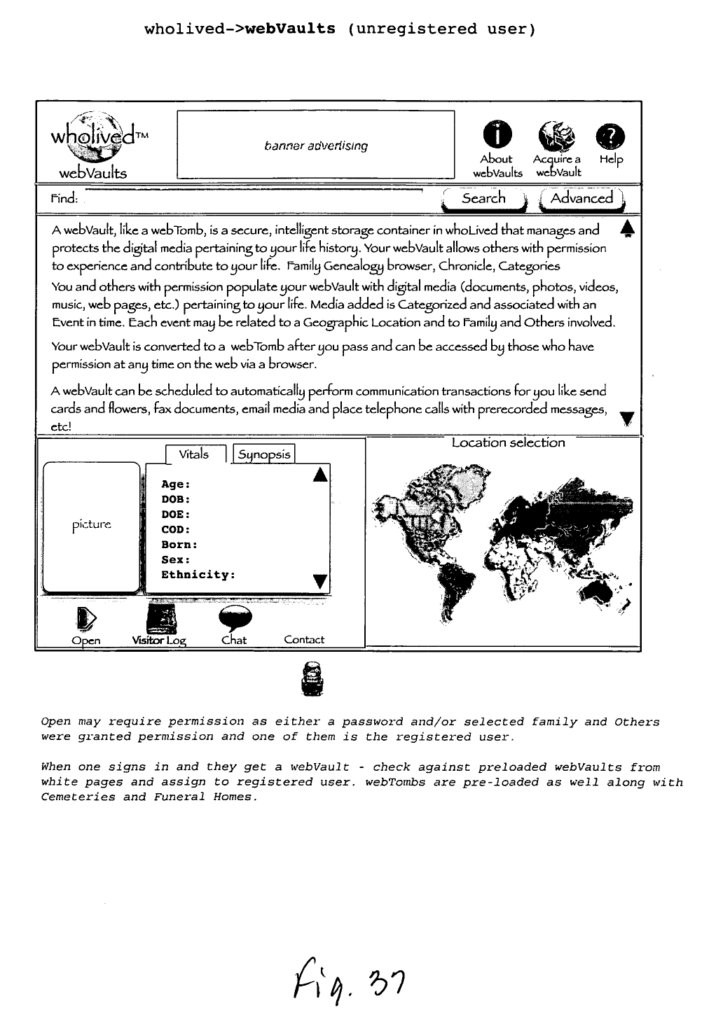

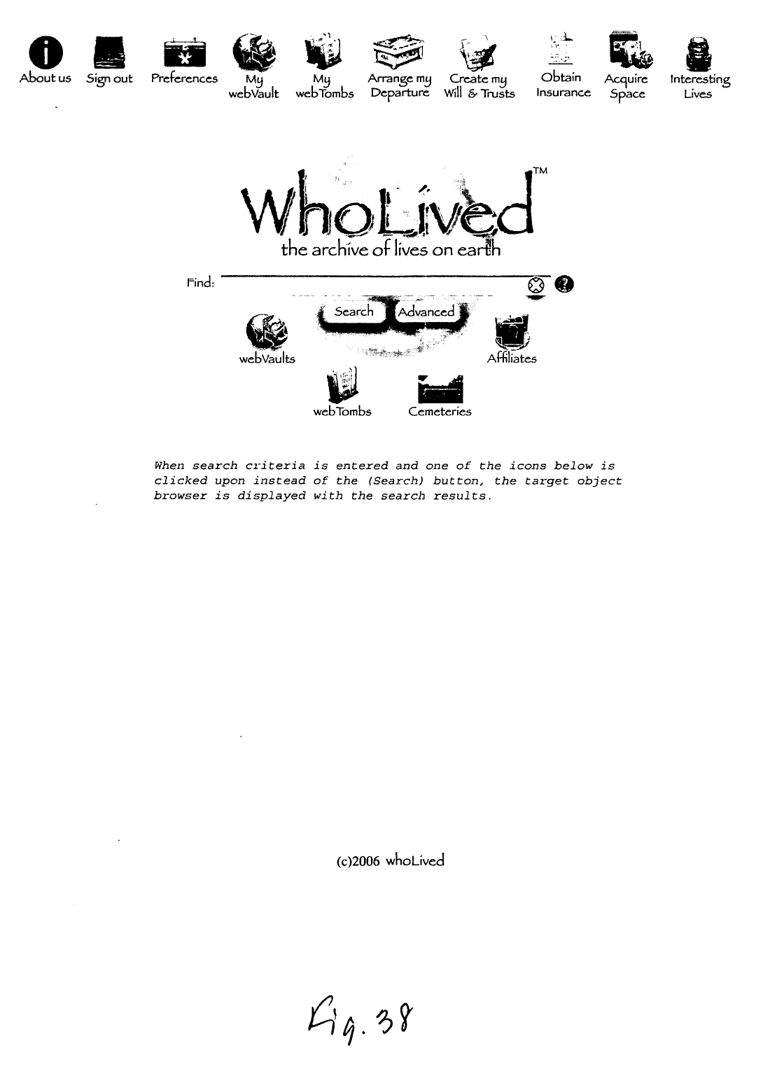

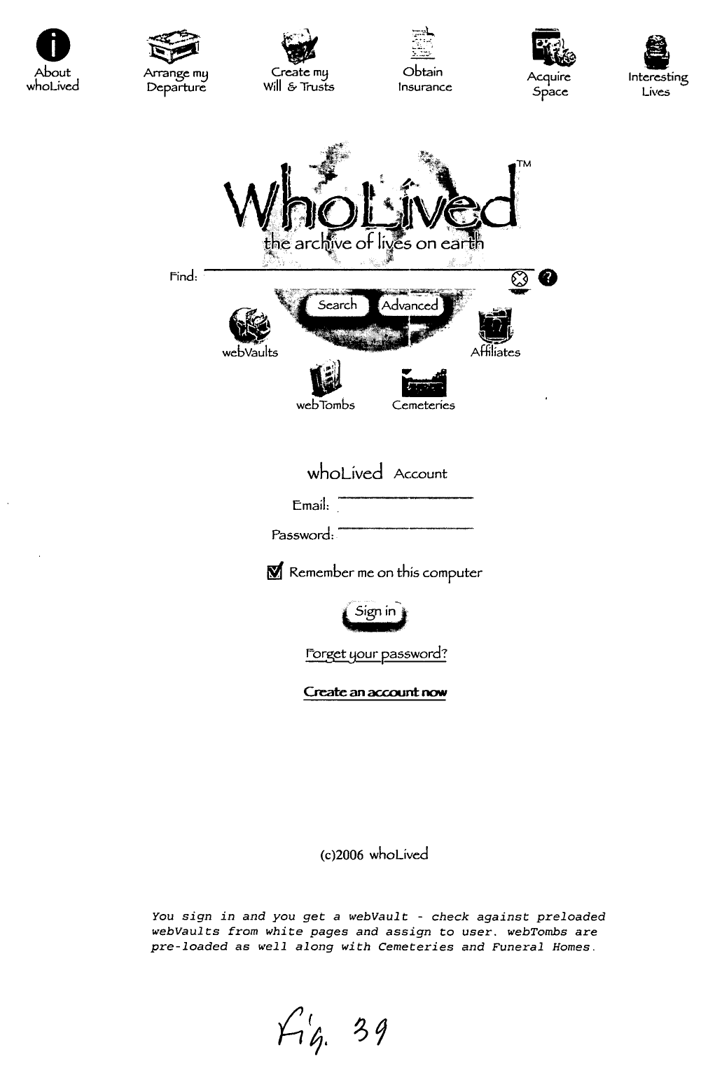

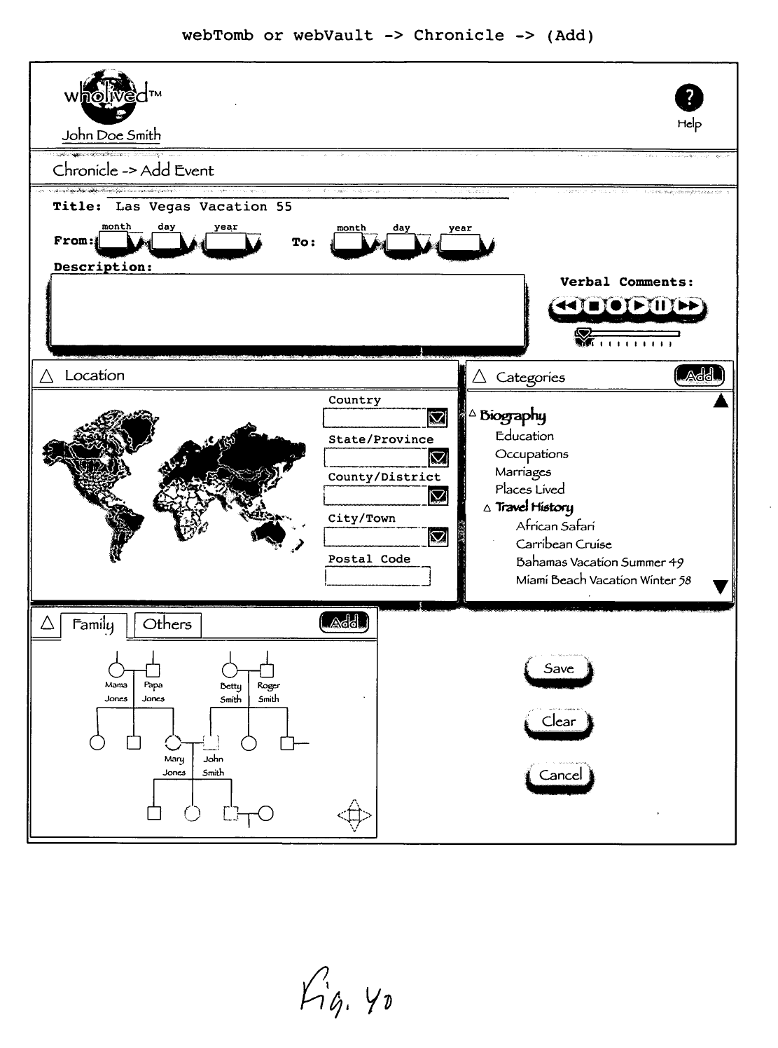

Criteria dialog—select parameter
Condition dialog—select condition related to Value
Value dialog—select from list of canned values or enter value as text string
Time and Location dialog—qualify certain criteria by dates of occurrence and geographical location(s)
(Add) and (Delete) buttons—used to add or remove statement in a Query
Query dialog that displays the constructed Query
Set of query management buttons: Save, Open, Clear, Cancel and Search/Submit
   The user constructs a query by first selecting desired Criteria, specifying the condition and expected Value then specify criteria dependant dates and times involved and/or desired locations involved. For example: Sex=Male is not associated with any dates and times or geographical locations but Education->Degree=BS could be further specified with from/to dates and a geographical location.
   Once a query statement has been constructed, the user may add that statement to be displayed in the Query dialog by selecting the (Add) button. Multiple statements in a Query are AND together. User entered Value text may include the logical operators: AND, OR and XOR.
   The (Delete) button can be used to remove selected statement(s) in the Query dialog.
   There exist a plethora of criteria from which to construct powerful queries.
   Once a Query is complete the user may execute it by selecting the (Search) button.
   Queries may also be saved and opened by registered users.
   The (Clear) button asks the user if he/she wants to erase all the statements in the Query dialog
   The (Cancel) button cancels a search in progress
   The results of a search opens a webTomb/webVault list page as depicted in FIGS. 23 and 24.
   WebVaults is selected on the home page as depicted in FIG. 19, and will be described below by non-limiting example.
   FIG. 19
   Wholived->webVaults
   Empty webVault list if no data supplied.
   Icons
   About webVaults—opens a description of webVaults page
   Acquire a webVault—opens a purchase webVault page
   Help—How the page works
   User enabled to search for webVaults by name, etc and display results
   webTombs is selected on the home page which opens a webcemetery browser of wholived by default as depicted in FIG. 20, and will be described below by non-limiting example.
   FIG. 20
   Wholived->webTombs
   Wholived cemetery browser is displayed when webTombs is selected without any data supplied
   Icons
   About webTombs—opens a description of webTombs and their features & services
   Acquire a webTomb—opens a purchase webTomb page
   Help—How the page works
   In this scenario, all webTombs regardless of what webCemeteries they may reside also reside in wholived.
   User enabled to search for webTombs by name, etc., and display results as a list, set of icons or virtual cemetery view. See FIG. 23 and FIG. 20.
   Selected webTomb's Vital Information and Biographical synopsis is displayed along with its location on the map.
   The map may be used to select areas on the earth to filter webTombs by geographic location.
   User may elect to
   open the selected webTomb,
   View the Visitor Log
   Chat—using text, audio and video. Recordings added to Visitor Log
   Place Flowers on the icon of the webTomb in the webcemetery browser
   Contact the Custodian (generally to request permissions).
   A Cemetery selection dialog may be opened to select a cemetery or closed as depicted.
   Cemeteries is selected on the home page as depicted in FIG. 21, and will be described below by non-limiting example.
   FIG. 21
   Wholived->Cemeteries
   Wholived cemetery list page is displayed when Cemeteries is selected without any data supplied. If data supplied matches only one cemetery, the webcemetery browser would be displayed.
   Icons
   About Cemeteries—opens a description of Cemeteries and webCemeteries and their features & services
   Acquire a webCemetery—opens a purchase webCemetery and Affiliate registry page
   Help—How the page works
   User enabled to search for Cemeteries by name via (Find) button or selection from list and display information about the selected cemetery. Cemeteries may be filtered by human or pet types.
   The visibility of cemeteries on the page can be filtered by physical cemeteries, virtual cemeteries and my cemeteries operated by the signed in user.
   Cemeteries may be further filtered by geographical location by selecting areas on the map
   The user may open a webCemetery browser of the selected cemetery to visit the webTombs therein by selecting the (Visit) button.
   Users may contact the selected cemetery via its associated information provided like telephone number (via VoIP) or email address or website URL, etc.
   A Cemetery is visited on the Cemeteries page which opens a webCemetery browser as depicted in FIG. 25, and will be described below by non-limiting example.
   FIG. 25
   Wholived->Cemeteries->webCemetery browser
   webCemetery browser is displayed of the cemetery specified and Visited in the wholived->Cemeteries page as depicted in FIG. 21. It displays only the webTombs associated with it.
   Icons
   Acquire a webTomb—opens a description of webTombs and its features and services page
   Acquire a webSafe—opens a description of webSafe and its features and services page
   Make Arrangements—opens a description of death preparation related services offered by the webCemetery provider (operator/owner).
   Get a map—opens a topological navigation map of the cemetery page allowing the user to save or print.
   About us—basic and contact information about the provider of the webCemetery (e.g. Funeral Home, Veterinarian, Government Agency, etc.)
   Help—How the page works
   webTombs residing in the webCemetery may be viewed as a list, as a set of icons or as a virtual reality walk about via the Cemetery view. List view enables sorting the contained webTombs by Vital information parameters.
   In Cemetery view the user navigates the virtualized cemetery by directing the mouse in the desired direction of travel. The display simulates what the user would see if he/she were actually walking the cemetery. When positioned in front of a webTomb it is highlighted as depicted with information about the occupant visible. The user may select a webTomb by simply clicking on it any where in the cemetery view.
   User enabled to search for other webTombs in the current webCemetery by name and other vital information. The webTombs found matching the query filter the visibility of the contained webTombs displayed.
   Vital information and biographical synopsis about the occupant of the selected webVault/webTomb is displayed along with actions that can be performed:
   User may elect to
   open the selected webTomb,
   View the Visitor Log
   Chat—using text, audio and video. Recordings added to Visitor Log
   Place Flowers on the icon of the webTomb in the webCemetery browser
   Contact the Custodian (generally to request permissions).
   An extended version of a webCemetery browser is depicted in FIG. 26, and will be described below by non-limiting example.
   FIG. 26
   Wholived->Cemeteries with combined webCemetery browser
   Wholived cemetery list page is displayed when Cemeteries is selected without any data supplied. If data supplied matches only one cemetery, the webcemetery browser would be displayed.
   Icons
   About Cemeteries—opens a description of Cemeteries and webCemeteries and their features & services
   Acquire a webCemetery—opens a purchase webCemetery and Affiliate registry page
   Help—How the page works
   User enabled to search for Cemeteries by name via (Find) button or selection from list and display information about the selected cemetery. Cemeteries may be filtered by human or pet types.
   The visibility of cemeteries on the page can be filtered by physical cemeteries, virtual cemeteries and my cemeteries operated by the signed in user.
   Cemeteries may be further filtered by geographical location by selecting areas on the map
   An integrated webCemetery browser is displayed of the selected cemetery and displays only the webTombs associated with it.
   Icons
   Acquire a webVault—opens a purchase a webVault with plans to reside in this cemetery page
   Acquire a webTomb—opens a description of webTombs and its features and services page
   Acquire a webSafe—opens a description of webSafe and its features and services page
   Make Arrangements—opens a description of death preparation related services offered by the webCemetery provider (operator/owner).
   Get a map—opens a topological navigation map of the cemetery page allowing the user to save or print.
   About us—basic and contact information about the provider of the webCemetery (e.g. Funeral Home, Veterinarian, Government Agency, etc.)
   webTombs residing in the webCemetery may be viewed as a list, as a set of icons or as a virtual reality walk about via the Cemetery view. List view enables sorting the contained webTombs by Vital information parameters.
   In Cemetery view the user navigates the virtualized cemetery by directing the mouse in the desired direction of travel. The display simulates what the user would see if he/she were actually walking the cemetery. When positioned in front of a webTomb it is highlighted as depicted with information about the occupant visible. The user may select a webTomb by simply clicking on it any where in the cemetery view.
   User enabled to search for other webTombs in the current webCemetery by name and other vital information. The webTombs found matching the query filter the visibility of the contained webTombs displayed.
   Vital information and biographical synopsis about the occupant of the selected webVault/webTomb is displayed along with actions that can be performed:
   User may elect to
   open the selected webTomb,
   View the Visitor Log
   Chat—using text, audio and video. Recordings added to Visitor Log
   Place Flowers on the icon of the webTomb in the webCemetery browser
   Contact the Custodian (generally to request permissions).
   Affiliated Funeral Homes page is depicted in FIG. 22, and will be described below by non-limiting example.
   FIG. 22
   Wholived->Affiliates->Funeral Homes
   Wholived funeral home list page is displayed when Funeral Homes is selected on the wholived->Affiliates page.
   Icons
   About Funeral Homes—opens a description of Funeral Homes and Affiliate registry page
   Help—How the page works
   User enabled to search for Funeral Homes by name via (Find) button or selection from list and display information about the selected funeral home.
   Funeral homes may be further filtered by geographical location by selecting areas on the map
   The user may open a webCemetery browser of the webCemetery operated by the selected funeral home to visit the webTombs therein by selecting the (Cemetery) button.
   Users may contact the selected funeral home via its associated information provided like telephone number (via VOIP) or email address or website URL, etc.
   Wholived Affiliates are
Organizations that sell webTombs/webVaults
Organizations that purchase webCemeteries
Organizations that advertise related services
   A webTomb browser is depicted in FIG. 27, and will be described below by non-limiting example.
   FIG. 27
   webTomb Browser
   Icons
   View the Visitor Log
   Chat—with occupant using text, audio and video. Recordings added to Visitor Log
   Send Flowers—opens send flowers to selected Family, Friends and Others page
   Send a Card—opens email multimedia card to selected Family, Friends and Others page
   Give to Charity—opens give to occupant's favorite Charities page
   Get Certificates—opens acquire specific certificates (i.e. Birth) page
   Get a picture—request a photograph of the actual tombstone in the cemetery
   Help
   The media comprising the information about the occupant of the webTomb is organized as a sequence of categorized events each with a specified description, data and times of occurrence, geographical location(s) involved and Family, Friends and Others involved.
   The webTomb browser enables the user to view the occupant's Vital information and Biographical synopsis AND access, filter and display other information by selecting one or more
Categories/SubCategories pertaining to the desired information AND/OR
Events in the life of the occupant via the integrated Chronicle dialog AND/OR
Family, Friends or Others associated with the desired information via the integrated Family Genealogy dialog.
   Example: when one or more family members are selected in the integrated Family Genealogy dialog, all information about the occupant that is related to the selected Family is displayed. If one or more events in the Chronicle are selected the all information about the occupant related to the selected events is displayed. If both family and events are selected then only that information about the occupant that relates to the selected event(s) AND the selected family are displayed (i.e. filter by event and people involved). This method of information selection and filtering works also with selected categories/subcategories of information as well.
   Background music may be played during viewing as specified by the wholived->webTomb->Custodian->Preferences
   The webTomb browser enables the user via controlled access to add new information (media) as well as edit and delete selected information about the displayed webTomb's occupant.
   Icons
   Cemetery—open webCemetery browser containing this webTomb and select it
   webSafe—open associated webSafe browser
   Actions—opens Actions manager page
   Custodian—open custodian (admin) page
   When a custodian is signed in, the webTomb browser may display Possible linked Events Exist annunciators in the Chronicle dialog and/or Family Genealogy dialog to inform the custodian that possible media related to the occupant by common events or family exist and should be validated for incorporation. See Relational Linkages for more detail.
   Predefined Categories of information are depicted in FIG. 28, and will be described below by non-limiting example.
   FIG. 28
   webTomb or webVault Category definitions.
   Each piece of media comprising the Information about the occupant of a webVault/webTomb may be associated (when added or edited) with one or more events in the life of the occupant. Each event can have a title, textual and audio description and correspond to one or more Categories of information type, the date and time of occurrence of the event, the geographical location(s) of the occurrence and one or more family, friends and Others involved in the event.
   These categories and subcategories listed are not exhaustive, and many additional categories and subcategories may be included in alternative embodiments of the present invention as should be understood by those of ordinary skill in the art in view of the present discussion.
   Each subcategory represents a set of data further describing the associated media. Example: Biography->Education consists of a set of Events related to the occupant's education and each education entry describes the details of the education such as school name, address, degrees obtained, etc.
   Finding, displaying and managing information related to a specified Category->subcategory by a webTomb or webVault browser is depicted in FIG. 29, and will be described below by non-limiting example.
   FIG. 29
   webTomb or webVault->Biography->Places Lived
   webTomb Browser displaying information related to biography->Places lived
   Icons
   View the Visitor Log
   Chat—with occupant using text, audio and video. Recordings added to Visitor Log
   Send Flowers—opens send flowers to selected Family, Friends and Others page
   Send a Card—opens email multimedia card to selected Family, Friends and Others page
   Give to Charity—opens give to occupant's favorite Charities page
   Get Certificates—opens acquire specific certificates (i.e. Birth) page
   Get a picture—request a photograph of the actual tombstone in the cemetery
   Help
   The webTomb browser enables the user to access information related by Category and subcategories.
   List view or icon view of biography subcategories is available
   Background music may be played during viewing as specified by the webTomb->Custodian->Preferences
   A Chronicle dialog is displayed listing the defined events in the life of the occupant. It may be opened or closed.
   A Family Genealogy is displayed with links to Other Relationships (short cut to Biography->Relationships). It may be opened or closed.
   Subcategory (Places Lived) information dialog is displayed with a list of entries (i.e. place lived) viewed as a list or as icons. The geographical location or specific type of Information associated with a selected entry can be accessed by selecting one of the icons:
   Location—map depicted location of entry in subcategory
   Documents—text, application docs, scan or fax images
   Photos
   Video—video clips and movies
   Speech—audio clips
   Music
   When in list view the Subcategory information dialog enables the user to sort the entries by its associated data via their headers in the list.
   Icons
   Cemetery—open webcemetery browser containing this webTomb and select it
   webSafe—open associated webSafe browser
   Actions—opens Actions manager page
   Custodian—open custodian (admin) page
   Enables user to add an entry in the subcategory as well as edit or delete selected entries with permission.
   The chronicle dialog and the family genealogy dialog both may be filtered to display only those events and family involved in the selected subcategory entry (i.e. Places Lived).
   When a custodian is signed in, the webTomb browser may display Possible links Exist annunciators in the Chronicle dialog and/or Family Genealogy dialog to inform the custodian that possible media related to the occupant by shared common events or family exist and should be validated for incorporation.
   Finding, displaying and managing information related to a specified Event by a webTomb or webVault browser is depicted in FIG. 30, and will be described below by non-limiting example.
   FIG. 30
   webTomb or webVault->Chronicle
   webTomb Browser displaying information related to a selected event in the Chronicle dialog.
   The webTomb browser enables the user to access information related by Events that are listed in the Chronicle dialog in chronological order.
   A Family Genealogy is displayed with links to Other Relationships. It may be opened or closed.
   An Event (i.e. First Marriage) information dialog is displayed with a set of associated data. The geographical location or specific type of Information associated with a selected event can be accessed by selecting one of the icons:
   Location—map depicting the location of where the event occurred
   Documents—text, application docs, scan or fax images related to the selected event
   Photos—photographs related to the selected event
   Video—video clips and movies related to the selected event
   Speech—audio clips related to the selected event
   Music—music related to the selected event
   Icons
   Cemetery—open webCemetery browser containing this webTomb and select it
   webSafe—open associated webSafe browser
   Actions—opens Actions manager page
   Custodian—open custodian (admin) page
   The family genealogy dialog may be filtered to display only those family and others involved in the selected event (i.e. First Marriage).
   Enables user to define new event in the Chronicle as well as edit or delete selected events with permission.
   Finding, displaying and managing information related to specified Family member(s) and Others by a webTomb or webVault browser is depicted in FIG. 31, and will be described below by non-limiting example.
   FIG. 31
   webTomb or webVault->Family Genealogy
   webTomb Browser displaying information related to selected family in the Family Genealogy dialog.
   The webTomb browser enables the user to access information involving selected Family, Friends and others in the family genealogy dialog.
   A Chronicle dialog is displayed. It may be opened or closed.
   A Family (i.e. Sally Anne Smith) information dialog is displayed with a set of associated data. The geographical location or specific type of Information associated with a selected family member can be accessed by selecting one of the icons:
   Location—map depicting the location of where the selected family member resides
   Documents—text, application docs, scan or fax images related to the selected family member
   Photos—photographs related to the selected family member
   Video—video clips and movies related to the selected family member
   Speech—audio clips related to the selected family member
   Music—music related to the selected family member
   Icons
   Cemetery—open webCemetery browser containing this webTomb and select it
   webSafe—open associated webSafe browser
   Actions—opens Actions manager page
   Custodian—open custodian (admin) page
   The Chronicle dialog may be filtered to display only those events involving the selected family member(s) (i.e. Sally Anne Smith).
   Enables user to add new family members and Others as well as edit or delete selected family members and Others with permission.
   Selecting Others in the Family Genealogy dialog displays the biography->Relationship subcategories list or icon view.
   If Possible Family Exist is annunciated in the Family Genealogy dialog the custodian can select it to validate possible family members for incorporation into the Family Genealogy. This occurs because Wholived generates candidates and notifies the potential relative(s) that new family members may exist.
   Finding, displaying and managing photographic information related to a specified Event by a webTomb or webVault browser is depicted in FIG. 32, and will be described below by non-limiting example.
   FIG. 32
   webTomb or webVault->Chronicle->Event->Photos
   webTomb Browser displaying photographic information related to selected event in the Chronicle dialog.
   The webTomb browser enables the user to access information involving selected Events in the Chronicle dialog.
   An Event (i.e. First Marriage) information dialog is displayed with a set of associated data. The geographical location or specific type of Information associated with a selected family member can be accessed by selecting one of the icons:
   Location—map depicting the location of where the selected family member resides
   Documents—text, application docs, scan or fax images related to the selected family member
   Photos—photographs related to the selected family member
   Video—video clips and movies related to the selected family member
   Speech—audio clips related to the selected family member
   Music—music related to the selected family member
   The information displayed pertains to a selected Photo from a set of photos related to the selected event. The related photos may be displayed as a list or a set of icons.
   The enlargement and data associated with a selected photo is also displayed and enables the user to quickly navigate the set of related photos.
   This example works for the other information media types as well.
   Finding, displaying and managing all media types related to a person/pet by a webTomb or webVault browser is depicted in FIG. 33, and will be described below by non-limiting example.
   FIG. 33
   webTomb or webVault->Biography->Media->Photos
   webTomb Browser displaying all the photographic information associated with a webTomb occupant (i.e. John Doe Smith).
   The associated photos are displayed as a list, set of icons or thumbnail images.
   The information displayed pertains to a selected Photo from the set of related photos.
   The enlargement and data associated with a selected photo is also displayed and enables the user to quickly navigate the set of related photos.
   Four additional dialogs are displayed that may be opened or closed:
   Categories dialog—indicates subcategories related to selected photo
   Time and Location dialog—displays dates, times and geographical location related to selected photo
   Chronicle dialog—indicates event(s) associated with selected photo
   Family Genealogy dialog—indicates family and others involved with selected photo/
   The user may filter the display of related photos by
   selecting one or more Categories/subcategories from the Categories dialog
   AND/OR
   specifying dates and times and geographical locations from the Time and Location dialog
   AND/OR
   selecting one or more Events in the Chronicle dialog
   AND/OR
   Selecting one or more Family and/or Others from the Family Genealogy dialog
   For example: display only those photos that are related to all entries in biography->birthdays AND that occurred over the last 10 years in Chicago, USA AND that involved Uncle Bob. Note: no Event was selected in this query.
   All supported media types (Text, Documents, Images, URLs, etc.) are displayed by a webTomb browser in a similar fashion to that of Photos.
   Associating media to be added to a webTomb or webVault is depicted in FIG. 34, and will be described below by non-limiting example.
   FIG. 34
   Adding Media to a webTomb or webVault
   webTomb or webVault->Biography->Media->Photos->Add
   A webTomb Browser is displaying photographic information to be added to a webTomb (i.e. John Doe Smith).
   The photos to be added are displayed as a list, set of icons or thumbnail images.
   The information dialog displayed pertains to one or more selected Photos from the set of photos to be added. The user employs this dialog to enter primary data associated with the selected photo(s) such as Dates and Times, Title, Description, Comments, and verbal comments.
   Four additional dialogs are displayed that may be opened or closed. Any or all of these dialogs may be employed by the user to further specify the information added:
   Categories dialog—user selects subcategories related to selected photo(s)
   Location dialog—user specifies geographical location(s) related to selected photo(s)
   Chronicle dialog—User indicates event associated with selected photo(s)
   Family Genealogy dialog—User specifies family and others involved in selected photo(s)
   Once the selected photo(s) have been defined and related the user may incorporate the selected media into the webTomb or webVault by selecting the (Save) button.
   All supported media types (Text, Documents, Images, URLs, etc.) all are added via a webTomb browser in a similar fashion to that of Photos.
   Display and management of the information associated with the chronological sequence of events comprising a persons'/pets' life is depicted in FIG. 36, and will be described below by non-limiting example.
   FIG. 36
   webTomb or webVault->Chronicle
   Enables the user to view the historical information associated with a webTomb or webVault as a sequence of Events in the life of the occupant.
   The Chronicle dialog in a webTomb Browser can open into a Chronicle of Events page
   The Chronicle of Events page enables the user to access information related to selected Event(s) that are displayed in two different chronological timeline of events dialogs.
   A Categories dialog is displayed to show categories relating to selected events or to filter events based upon categories/subcategories selected. It may be opened or closed.
   An Event (i.e. Sr Research Scientist at NOAA) information dialog is displayed with a set of associated data. The geographical location or specific type of Information associated with a selected event can be accessed by selecting one of the icons:
   Location—map depicting the location of where the event occurred
   Documents—text, application docs, scan or fax images related to the selected event
   Photos—photographs related to the selected event
   Video—video clips and movies related to the selected event
   Speech—audio clips related to the selected event
   Music—music related to the selected event
   Enables user to define new event in the Chronicle as well as edit or delete selected events with permission.
   Finding, displaying and managing information related to specified Family member(s) and Others by a Family Genealogy browser is depicted in FIG. 37, and will be described below by non-limiting example.
   FIG. 37
   webTomb or webVault->Family Genealogy
   Enables the user to view the historical information associated with a webTomb or webVault involving Family, Friends and Others in the life of the occupant.
   The Family Genealogy dialog in a webTomb Browser can open into a Family Genealogy browser.
   A Categories dialog is displayed to show categories involving to selected family/others or to filter family/others involved based upon categories/subcategories selected. It may be opened or closed.
   The family tree can be navigated and one or more family members may be selected. Information involving a selected family member is displayed in the information dialog with a set of associated data. The geographical location or specific type of Information associated with a selected family member can be accessed by selecting one of the icons:
   Location—map depicting the location of where the selected family member resides
   Documents—text, application docs, scan or fax images involving the selected family member
   Photos—photographs involving the selected family member
   Video—video clips and movies involving the selected family member
   Speech—audio clips involving the selected family member
   Music—music involving the selected family member
   Enables user to add new family members and Others as well as edit or delete selected family members and Others with permission.
   If Possible Family Exist is annunciated in the Family Genealogy browser the custodian can select it to validate possible family members for incorporation into the Family Genealogy. Once incorporated, any information associated with the new family member involving the occupant is added to the occupant's webTomb or webVault.
   A WebVault browser is depicted in FIG. 38, and will be described below by non-limiting example.
   FIG. 38
   webVault Browser
   Same as a webTomb browser with a few exceptions. See FIG. 27 description above regarding the webTomb browser.
   Icons
   View the Visitor Log
   Chat—with occupant using text, audio and video. Recordings added to Visitor Log
   Send Flowers—opens send flowers to selected Family, Friends and Others page
   Send a Card—opens email multimedia card to selected Family, Friends and Others page
   Give to Charity—opens give to occupant's favorite Charities page
   Help
   The media comprising the information about the occupant of the webVault is organized as a sequence of categorized events each with a specified description, data and times of occurrence, geographical location(s) involved and Family, Friends and Others involved.
   The webVault browser, according to this example, enables the user to view the occupant's Vital information and Biographical synopsis AND access, filter and display other information by selecting one or more
Categories/SubCategories pertaining to the desired information AND/OR
Events in the life of the occupant via the integrated Chronicle dialog AND/OR
Family, Friends or Others associated with the desired information via the integrated Family Genealogy dialog.
   Example: when one or more family members are selected in the integrated Family Genealogy dialog, all information about the occupant that is related to the selected Family is displayed. If one or more events in the Chronicle are selected the all information about the occupant related to the selected events is displayed. If both family and events are selected then only that information about the occupant that relates to the selected event(s) AND the selected family are displayed (i.e. filter by event and people involved). This method of information selection and filtering works also with selected categories/subcategories of information as well.
   Background music may be played during viewing as specified by the wholived->webVault->Custodian->Preferences
   The webVault browser enables the user via controlled access to add new information (media) as well as edit and delete selected information about the displayed webVault's occupant.
   Icons
   webSafe—open associated webSafe browser
   Actions—opens Actions manager page
   Custodian—open custodian (admin) page
   When a custodian is signed in, the webVault browser may display Possible linkages Exist annunciators in the Chronicle dialog and/or Family Genealogy dialog to inform the custodian that possible media related to the occupant by common events or family exist and should be validated for incorporation.
   A WebSafe browser is depicted in FIG. 39, and will be described below by non-limiting example.
   FIG. 39
   webSafe Browser
   wholived->webTomb or webVault->webSafe->Property->Real Estate
   a webSafe browser enables the user to view and manage the information related to personal property, financial activities and legal affairs
   a webSafe may only be opened from an open webTomb or webVault that contains it.
   Icons
   Administration—opens admin dialog page to specify webSafe operating parameters
   Actions—manage Actions
   Help
   The media comprising the information about the occupant's personal property, financial activities and legal affairs is organized into categories and subcategories.
   Displayed is Property->real estate and a list or icon view of associated real estate (subcategory) entries.
   The geographical location or specific type of Information associated with a selected entry can be accessed by selecting one of the icons:
   Location—map depicting the geographical location of the selected entry
   Documents—text, application docs, scan or fax images related to the selected entry
   Photos—photographs related to the selected entry
   Video—video clips and movies related to the selected entry
   Speech—audio clips related to the selected entry
   Music—music related to the selected entry
   Actions—manage Actions pertaining to the selected entry
   The webSafe browser enables the user to add new information as well as edit and delete selected information pertaining to a selected Category/subcategory.
   The list of categories and subcategories is not exhaustive, and many additional categories and subcategories may be included in alternative embodiments of the present invention as should be understood by those of ordinary skill in the art in view of the present discussion.
   Adding a new event to a webTomb or webVault Chronicle of Events is depicted in FIG. 40, and will be described below by non-limiting example.
   FIG. 40
   webTomb or webVault->Chronicle->(Add)
   Enables a user with permissions to add new Events associated with the life of a webTomb or webVault occupant and relate that event to one or more Categories and Family and Others involved in the new event.
   The Chronicle Event add page consists of an associated data dialog, Location dialog, Categories dialog and a Family Genealogy dialog.
   To add a new event, a user gives the new event a Title, From and To dates of occurrence, Textual description and verbal comments. In addition, the user may relate the new event to geographical location(s) in the Location dialog and/or one or more Categories defining the type(s) of event in the Categories dialog and/or one or more Family and Others involved in the event in the Family Genealogy dialog.
   Once the new event is defined, it may be saved by selecting the (Save) button.
   The (Clear) button erases any data or relations already input by the user
   The (Cancel) button cancels the addition and returns the user to the associated Chronicle browser or dialog.
   When relating a new event to one or more Categories the user simply selects which categories apply. Clicking on a selected Category de-selects it. Once a new event is added, all selected categories are given a new entry with the same title of the added event. In this example, there would be a new entry under Biography->Travel History entitled “Las Vegas Vacation 55”.
   Note: when a new entry is added in a Category->subCategory a corresponding event entitled the same as the new entry is made in the Chronicle that shares the same relational linkages to dates, location(s) and Family/Others specified for the new category entry.

Additional features and functions of alternative embodiments of an exemplary wholived computer system are discussed in more detail in the Provisional Patent Application No. 60/660,113, filed on Mar. 9, 2005, the entire disclosure of which being herein incorporated by reference.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A computer system comprising:
a computer server communicatively coupled with at least one communication network;
a database, communicatively coupled with the computer server, for storing a collection of multimedia information organized as a plurality of webtombs, each webtomb of the plurality of webtombs associated with a collection of multimedia information representing a past life, and each particular webtomb being associated with a particular collection of multimedia information that includes securely stored electronic information associated with a particular past life, such securely stored electronic information being accessible to only a user having an access code; and
a network interface, communicatively coupled with the database and the computer server, for providing remote access to the stored collection of multimedia information organized as the plurality of webtombs from a remote networked application communicating with the computer server from across the at least one communication network, a user using the remote networked application having remote access to such securely stored electronic information by providing the access code to the network interface.

2. The computer system of claim 1, wherein each particular webtomb including a websafe corresponding to the securely stored electronic information associated with the particular past life of the particular webtomb, such electronic information being securely stored in the websafe and being accessible to only a user having an access code for the websafe, a user using the remote networked application having remote access to such electronic information of the websafe by providing the access code to the network interface to access the electronic information being securely stored in the websafe.

3. The computer system of claim 2, wherein the securely stored electronic information in the websafe including electronic legal documents and/or financial information that are associated with the particular past life of the particular webtomb.

4. The computer system of claim 2, wherein the securely stored electronic information in the websafe including at least one script for the computer server to perform computer actions that are defined for the particular past life of the particular webtomb, the computer actions including any of:
communicating with another computer system to deliver thereto information that is associated with the securely stored electronic information in the websafe,
initiating financial transactions,
electronically transferring funds from one financial account to another financial account at one or more financial institutions,
sending a fax document to a destination specified in the securely stored electronic information,
sending an email message to a destination specified in the securely stored electronic information,
placing a telephone call to a destination specified in the securely stored electronic information, the placed telephone call including a play back of one or more pre-recorded messages to a call answering party,
creating and filing tax returns electronically, and
a combination thereof.

5. The computer system of claim 2, wherein the securely stored electronic information in the websafe including at least one script for the computer server to perform computer actions that are defined for the particular past life of the particular webtomb, the computer actions being scheduled according to defined time events associated with the particular past life of the particular webtomb.

6. The computer system of claim 1, wherein the database further for storing a collection of multimedia information organized as a plurality of webvaults, each webvault of the plurality of webvaults associate with a collection of multimedia information representing a present life, and each particular webvault being associated with a particular collection of multimedia information that includes securely stored electronic information associated with a particular present life, such securely stored electronic information being accessible to only a user having an access code, and the network interface further for providing remote access to the stored collection of multimedia information organized as the plurality of webtombs, and/or as the plurality of webvaults, from a remote networked application communicating with the computer server from across the at least one communication network, a user using the remote networked application having remote access to such securely stored electronic information, respectively for any of the particular webvault or the particular webtomb, by providing a respective access code to the network interface.

7. The computer system of claim 6, further including:
a web agent, communicatively coupled with the computer server, for searching for requested information stored in one or more network nodes across the at least one communication network, the requested information being related to a life, past or present, associated with a particular webvault, a particular webtomb, or both, and the requested information having been requested by a user of the computer server, the web agent further for gathering the requested information from the one or more network nodes and storing gathered requested information in the database in a collection of multimedia information associated with a particular webvault, a particular webtomb, or both.

8. The computer system of claim 1, further including:
a web agent, communicatively coupled with the computer server, for searching for requested information stored in one or more network nodes across the at least one communication network, the requested information being related to a past life associated with a particular webtomb, and the requested information having been requested by a user of the computer server, the web agent further for gathering the requested information from the one or more network nodes and storing gathered requested information in the database in a collection of multimedia information associated with a particular webtomb.

9. The computer system of claim 1, further including a biometric identification communication interface for communication across the at least one network with a remotely located biometric lock device to identify a user that is using the remote networked application and requesting access to the such securely stored electronic information, or to secured functions of the computer server.

10. The computer system of claim 1, wherein the collection of multimedia information organized as a plurality of webtombs is further organized as at least one webcemetery, each such at least one webcemetery comprising a collection of webtombs for a user using the remote networked application to do any of:
search through a particular webcemetery for locating the collection of multimedia information of a particular webtomb in the webcemetery, the particular webtomb corresponding to a particular past life associated thereto,
request a virtual walkthrough of a particular webcemetery to view virtual representations of webtombs in the webcemetery, each such viewed webtomb corresponding to a past life associated thereto, and
a combination thereof.

11. The computer system of claim 1, wherein the computer server receives user input for adding information to a particular collection of multimedia information associated with a particular webtomb, and wherein the computer server further for determining that received information for a particular collection of multimedia information associated with a first webtomb is also associated with a particular collection of multimedia information associated with a second webtomb, and upon such determination the computer server sending a notification message to a custodian of the second webtomb to alert the custodian that a possible link exists with the information being added to the particular collection of multimedia information associated with the first webtomb.

12. The computer system of claim 11, wherein the computer server alerts the custodian of the possible link existing with respect to information associated with the first webtomb, where the information includes reference to any of:
one or more events shared between the past life of the first webtomb and the past life of the second webtomb,
an unknown family member shared between the past life of the first webtomb and the past life of the second webtomb,
an unknown relationship exists between the past life of the first webtomb and the past life of the second webtomb, and
any combination thereof.

13. The computer system of claim 11, wherein the computer server alerts the custodian of the second webtomb regarding the possible link existing with respect to information associated with the first webtomb by:
displaying to the custodian the information being associated with the first webtomb; and
prompting the custodian to approve or reject the link and the incorporation of the information associated with the first webtomb in the collection of multimedia information associated with the second webtomb.

14. The computer system of claim 1, wherein the database further for storing a collection of multimedia information organized as a plurality of webvaults, each webvault of the plurality of webvaults associate with a collection of multimedia information representing a present life, and each particular webvault being associated with a particular collection of multimedia information that includes securely stored electronic information associated with a particular present life, such securely stored electronic information being accessible to only a user having an access code, and the network interface further for providing remote access to the stored collection of multimedia information organized as the plurality of webtombs, and/or as the plurality of webvaults, from a remote networked application communicating with the computer server from across the at least one communication network, a user using the remote networked application having remote access to such securely stored electronic information, respectively for any of the particular webvault or the particular webtomb, by providing a respective access code to the network interface, and wherein
the computer server for receiving user input for adding information to a particular collection of multimedia information associated with a particular webtomb or a particular webvault, and wherein the computer server further for determining that received information for a particular collection of multimedia information associated with a first webtomb or webvault is also associated with a particular collection of multimedia information associated with a second webtomb or webvault, and upon such determination the computer server sending a notification message to a custodian of the second webtomb or webvault to alert the custodian that a possible link exists with the information being added to the particular collection of multimedia information associated with the first webtomb or webvault.

15. A method in a wide area computer network including a networked computer server and an associated database and a plurality of remote networked computer systems, the method comprising:
providing to a remote networked application, that is operating in a remote networked computer system, access to a collection of webtombs organized in one or more webcemeteries, each webtomb of the collection of webtombs being associated with a collection of multimedia information stored in a database associated with a networked computer server, the each webtomb and its associated stored collection of multimedia information representing a past life;
receiving, from the remote networked application in the remote networked computer system, a request for a virtual walkthrough of a webcemetery;
providing to the remote networked application a virtual walkthrough of the webcemetery in response to the request, the virtual walkthrough presenting to a user of the remote networked application a graphical view of the webcemetery that allows the user to browse through a collection of webtombs of the webcemetery;
providing to the user, via the networked application, access to a collection of information of a user selected webtomb in the webcemetery; and
presenting to the user a visual representation of an actual tomb corresponding to a past life associated with a user selected webtomb.

16. The method of claim 15, wherein the providing to the user includes
presenting to the user at least one of vitals information, financial information, and legal information, associated with the past life of the user selected webtomb.

17. A computer system for providing user access to a collection of webtombs, the computer system comprising:
at least one computer server communicatively coupled with at least one communication network;
at least one database, communicatively coupled with the at least one computer server, for storing a collection of information organized as a plurality of webtombs and/or webvaults, each webtomb being associated with a collection of information representing a past life and each webvault being associated with a collection of information representing a present life; and
a web browser interface, communicatively coupled with the at least one database and the at least one computer server, for providing remote access to the stored collection of information organized as the plurality of webtombs and/or webvaults from a remote web browser communicating with the at least one computer server from across the at least one communication network, a user using the remote web browser having remote access to such stored collection of information organized as the plurality of webtombs and/or webvaults.

18. The computer system of claim 17, wherein the at least one computer server for receiving information associated with a particular life, past or present, and adding the received information to a particular collection of information associated with a particular webtomb or webvault associated with the particular life, past or present, and wherein the at least one computer server further for determining that received information associated with a first webtomb or webvault is also associated with a second webtomb or webvault, and upon such determination the at least one computer server sending a notification message to a custodian of the second webtomb or webvault to alert the custodian that a possible link exists with the received information and with the life, past or present, associated with the first webtomb or webvault.

19. The computer system of claim 18, wherein the at least one computer server alerts the custodian of the second webtomb or webvault regarding the possible link existing with respect to information associated with the first webtomb or webvault by:
displaying to the custodian the information being associated with the first webtomb or webvault; and
prompting the custodian to approve or reject the link and the incorporation of the information associated with the first webtomb or webvault in the collection of information associated with the second webtomb or webvault.

20. The computer system of claim 19, wherein the at least one computer server, in response to receiving an approval by the custodian, storing the information in the collection of information associated with the second webtomb or webvault.

21. The computer system of claim 17, further including:
a web agent, communicatively coupled with the at least one computer server and the at least one database, for searching for information stored in one or more network nodes across the at least one communication network, the information being associated to one of a past life associated with a particular webtomb and a present life associated with a particular webvault, the web agent further for gathering the information from the one or more network nodes and storing the gathered information in the at least one database in a collection of information associated with a respective particular webtomb or particular webvault.

22. The computer system of claim 17, further including:
a linkage search agent, communicatively coupled with the at least one computer server and the at least one database, for searching the at least one database to determine heuristically possible linkages between different webtombs and/or webvaults, the possible linkages being determined based at least in part on any of:
commonly shared information stored in the collection of information associated with each of the different webtombs and/or webvaults,
a shared event associated with both of the different webtombs and/or webvaults,
a shared date and time and geographic location of any event associated with both of the different webtombs and/or webvaults,
a shared family member associated with both of the different webtombs and/or webvaults,
a shared friend associated with both of the different webtombs and/or webvaults,
a shared relationship between a life, past or present, and each of the different webtombs and/or webvaults, and
any combination thereof.

23. The computer system of claim 22, wherein the at least one computer server automatically determines a possible genealogy map, or family tree, for a particular life, past or present, associated with a particular webtomb or webvault, respectively, by instructing the linkage search agent to identify possible genealogy linkages, comprising genealogy relationships, between
the particular webtomb or webvault associated with the particular life, past or present, respectively, and
other webtombs and/or webvaults having their collection of information stored in the at least one database.

24. The computer system of claim 17, wherein the stored collection of information associated with each of the plurality of webtombs and/or webvaults is organized by specific information associated with
a category or type of information, and
one or more events in the life, past or present, represented by the each webtomb or webvault, respectively, each event being associated with
a category or type of event,
a date and time of occurrence of the event,
geographic location or locations of occurrence of the event,
family involved in the event,
friends involved in the event,
any other life, past or present, involved in the event, and
any combination thereof.
